(19) United States
(12) Patent Application Publication
(10) Pub. No.: US 2007/0286644 A1
(43) Pub. Date: Dec. 13, 2007

(54) Image forming apparatus and image forming method

(75) Inventor: Ichiro Takegawa, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/604,049

(22) Filed: Nov. 24, 2006

(30) Foreign Application Priority Data
Jun. 8, 2006 (JP) 2006-159812

(51) Int. Cl. G03G 15/00

(52) U.S. Cl. 399/159

(57) ABSTRACT

An image forming apparatus includes a photoreceptor, a latent image-forming unit that forms an electrostatic latent image on the surface of the photoreceptor with light, a developing unit that develops the electrostatic latent image using a toner to form a toner image, a color data-applying unit that applies the color data with light to the toner image, a transferring unit that transfers the toner image onto a surface of a recording medium, a fixing unit that fixes the toner image onto the surface of the recording medium, and a color formation unit that forms color of the toner image, the photoreceptor having a surface layer that scatters or absorbs the light which the color data applying unit applies to the toner image and that transmits the light which the latent image-forming unit applies to form the electrostatic latent image.

### BACKGROUND

(1) Technical Field

The present invention relates to an image forming apparatus and an image forming method employing an electrostatic recording system.

(2) Related Art

In a recording apparatus in which color images are obtained by an electrophotographic system, basic three primary colors have been so far developed according to respective image data, and the toner images are overlaid in sequence to obtain color images. Regarding a specific structure of an apparatus, a so-called four-cycle apparatus in which a step of developing each color on one photoreceptor drum having a latent image formed thereon by an image forming method and transferring the images on a transfer medium is repeated to obtain color images, a tandem apparatus in which a photoreceptor drum and a developing device are provided for each image forming unit of each color and toner images are continuously transferred in sequence upon moving a transfer member to obtain color images, and the like have been known.

These apparatus are in common with each other in that plural developing devices are provided for respective colors. Accordingly, four developing devices for three primary colors and block color are required in the usual color image formation. Further, in the tandem apparatus, four photoreceptor drums are required according to the respective four developing devices, so that a unit by which to synchronously operate these four image forming units is needed. Thus, an increase in size of the apparatus and an increase in cost are unavoidable.

### SUMMARY

According to an aspect of the invention, there is provided an image forming apparatus that includes; a photoreceptor, a latent image-forming unit that forms an electrostatic latent image on the surface of the photoreceptor with light, a developing unit that develops the electrostatic latent image using a toner to form a toner image, the toner being controlled to be in a color forming state or in a non-color forming state by being applied with color data, a color data-applying unit that applies the color data with light to the toner image formed on the surface of the photoreceptor, a transferring unit that transfers the toner image color data applied onto a surface of a recording medium, a fixing unit that fixes the transferred toner image onto the surface of the recording medium, and a color formation unit that forms color of the toner image,

the photoreceptor having a surface layer that scatters or absorbs the light which the color data applying unit applies to the toner image and that transmits the light which the latent image-forming unit applies to form the electrostatic latent image.

### BRIEF DESCRIPTION OF THE DRAWINGS

Exemplary embodiments of the invention will be described in detail based on the following figures, wherein:

FIG. 1 is a schematic structural view showing an example of an image forming apparatus of the aspect of the invention;

FIG. 2 is a graph showing a relation of properties of a photoreceptor and a wavelength of exposure light;

FIG. 3 is a block diagram of circuits in a printing controller;

FIGS. 4A and 4B are schematic sectional views describing a color formation mechanism of a toner as an example of a structure of a fixing device in the aspect of the invention, in which FIG. 4A illustrates a color formation part and FIG. 4B its enlarged state;

FIG. 5 is a graph showing an absorption spectrum of a dye used in a surface layer of a photoreceptor; and

FIG. 6 is a graph showing spectral sensitivity of a photoreceptor.

### DETAILED DESCRIPTION

The aspect of the invention will be described in detail below.

The toner used in the aspect of the invention has such a function that, for example, when respective particles of the toner are exposed to lights having different wavelengths, they maintain a state capable of forming colors corresponding to the different wavelengths or a state incapable of forming colors (non-color-forming). That is, the toner has there inside a color-forming substance (further a color formation part containing the same) capable of color formation by applying color data with light. The toner is controlled to maintain a color-forming or non-color-forming state by applying color data with light.

The description “applying color data with light” here referred to means that light(s) of one or more specific wavelength(s) is(are) selectively applied, or no light is applied, to a desired region of a toner image to control a color-forming/non-color-forming state or a color tone in color formation in the respective toner particles constituting the toner image.

Such a toner is not particularly limited so long as the foregoing function can be exhibited. Examples thereof can include toners described in JP-A-63-311364 and JP-A-2003-330228, toners which are profitably used in the aspect of the invention as will be later described, and the like.

In the image forming apparatus (image forming method) using this toner, such a toner is provided in one developing unit, an electrostatic latent image is formed on an image support with a logic sum of image formation data of four colors, cyan (C), magenta (M), yellow (Y) and black (K), the electrostatic latent image is developed with the toner to form a toner image, and, for example, the toner image is then exposed to lights of wavelengths corresponding to the color data to impart the color data to the toner image. Subsequently, the toner image with the color data applied is transferred onto a recording medium, and then fixed on the recording medium with heat and pressure. At this time, the reaction of color formation of the toner is conducted with the heat to obtain a color image.

Thus, since a full-color image can be obtained with one image support and one developing unit, a size of an image forming apparatus per se is as close to a size of a monochromic printer as possible to enable reduction in size of an apparatus. In addition, there is no need to laminate toners according to colors in forming a toner image. It is therefore possible to control unevenness of an image surface and to make uniform the gloss of the image surface. Further, a colorant such as a pigment is not used in the toner, making it possible to obtain a silver salt-like image.

When the foregoing toner is used as stated above, exposure for applying color data is conducted on a surface of a photoreceptor as an image support with the toner image formed in an image forming method of an ordinary electrophotographic system. Since intensity of the exposure light is considerably high, a photosensitive layer in the photoreceptor has been sometimes deteriorated with light.

Regarding this problem, the light deterioration of the photosensitive layer can be avoided when latent image-forming light in a wavelength region in which the photoreceptor has sensitivity is applied in forming the latent image and color data-applying light in a wavelength region which is scattered or absorbed on the surface of the photoreceptor is applied in applying the color data (image forming method of the aspect of the invention). In the aspect of the invention, it has been found that for practicing the foregoing method, it is most effective to use the image forming apparatus of the aspect of the invention provided with the photoreceptor having the surface layer which scatters or absorbs the color data-applying light applied via the color data-applying unit and which transmits the latent image-forming light applied via the latent image-forming unit.

More specifically, it has been found that as the surface layer of the photoreceptor, a surface layer with a light-selecting function of cutting light in a wavelength region of color data-applying light used to impart color data and transmitting only light in a wavelength region of latent image-forming light in forming a latent image (naturally, the photoreceptor has sensitivity in this wavelength region) is used, whereby, for example, near-infrared light for forming a latent image on the photoreceptor is satisfactorily transmitted through the surface of the photoreceptor and the photoreceptor has sensitivity to the near-infrared light even with a small amount of light to enable formation of the latent image and visible light of applying color data to the toner image is scattered or absorbed on the surface and is not transmitted through the photosensitive layer, with the result that the repetitive toner image formation and impartation of color data can be carried out without deterioration of the photoreceptor with the color data-applying light.

The description “scatters or absorbs color data-applying light” here indicates that transmittance of light applied to the surface layer is 1% or less. The description “transmits the latent image-forming light” indicates that transmittance of light applied to the surface layer is 50% or more. The description “photoreceptor has sensitivity” means that a latent image of a level without problem can be formed as a final image by the latent image-forming light in the image forming process applied.

An image forming apparatus (image forming method) which forms a color image by an electrophotographic process using a toner capable of controlling a color-forming or non-color-forming state according to color data applied with light, as used in the aspect of the invention, is described in detail below.

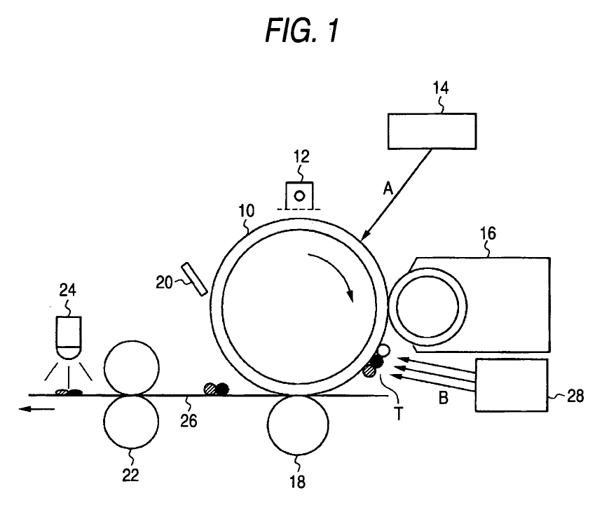

FIG. 1 is a schematic structural view showing an example of an image forming apparatus in the aspect of the invention. The image forming apparatus shown in FIG. 1 includes a photoreceptor 10, a charging device (charging unit) 12, an exposure device (latent image-forming unit) 14, a developing device (developing unit) 16, a transferring device (transferring unit) 18 and a fixing device (fixing unit) 22, which are all used in an ordinary electrophotographic process. In this apparatus, a color data-applying device 28 that applies color data to the photoreceptor 10 with a toner image after development is provided, and the fixing device 22 serves also as a color formation device (color formation unit) that allows color formation of the toner image. A light irradiation device (light irradiation unit) 24 that conducts light irradiation to a recording medium 26 for fixing the color of the toner or erasing a residual color is provided on the downstream side of the fixing device 22. Reference numeral 20 is a cleaner.

The structure of the image forming apparatus in the aspect of the invention is described along the steps in the image forming process.

<Latent Image Formation>

In the latent image formation, the entire surface of the photoreceptor 10 is first charged with the charging device 12, and exposure for forming the latent image is then conducted.

(Photoreceptor)

The photoreceptor 10 in this exemplary embodiment has a photosensitive layer and a surface layer on a substrate. As the structure of the photoreceptor 10 except the surface layer, any known structure can be used. However, as will be later described, since the color data-applying light to be applied to the photoreceptor 10 has to be cut on the surface in the aspect of the invention, the exposure wavelength region from the exposure device 14 for latent image formation is limited. Accordingly, it is advisable that the photosensitive layer in the photoreceptor 10 is also designed to have sensitivity to the wavelength region of the exposure light.

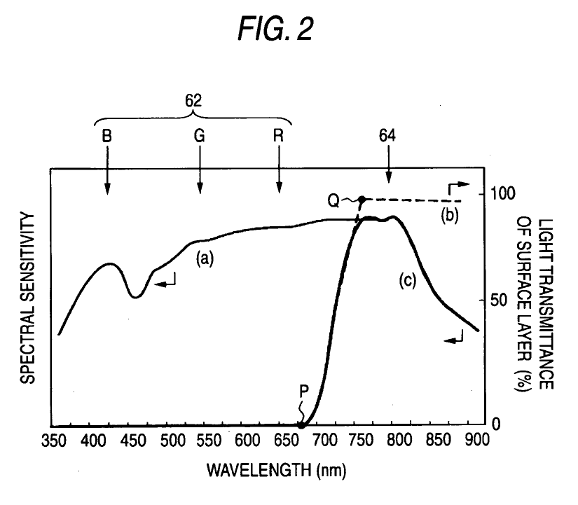

FIG. 2 is a graph showing a relation of properties of a photoreceptor and wavelengths of color data-applying light and latent image-forming light in the aspect of the invention.

In the drawing, a curve (a) shows a spectrum of spectral sensitivity of a photosensitive layer using phthalocyanine as a charge-generating material, a curve (b) a spectrum of light transmittance of a surface layer, and (c) a spectrum of spectral sensitivity of a photoreceptor after formation of a surface layer. Three arrows 62 show wavelengths of color data-applying lights (B (blue), G (green), R (red)), and an arrow 64 a wavelength of latent image-forming light.

Regarding examples of irradiation light sources herein, a semiconductor laser of 780 nm is used as a light source for latent image-forming light to be applied to a photoreceptor, and three light sources of 405 nm (B), 532 nm (G) and 657 nm (R) as light sources for color data-applying light to be applied to a toner image. Of course, wavelengths of these light sources may be different so long as a relation of spectral sensitivity of the photoreceptor and wavelengths of exposure sources is satisfied.

As shown in FIG. 2, since light transmittance of the surface layer is approximately 0% in a wavelength region (from approximately 400 to 700 nm) of the color data-applying light 62, sensitivity in this wavelength region is also approximately zero in the photoreceptor having this surface layer. Meanwhile, the light transmittance of the surface layer is abruptly increased in a wavelength region of more than approximately 700 nm. Accordingly, the original sensitivity of the photosensitive layer is recovered in this wavelength region to comply with this, and spectral sensitivity with a narrow effective sensitivity region as shown in a curve (c) is provided.

The use of the photoreceptor having such a spectral sensitivity makes it possible to prevent the foregoing light deterioration of the photosensitive layer because it little absorbs the color data-applying light 62 but absorbs only the latent image-forming light 64.

With respect to the wavelength of the latent image-forming light 64, when the wavelength of the exposure 62 (wavelength of light which the toner image absorbs) for applying color data to the toner image is 405 nm, 532 nm or 657 nm, the peak wavelength of irradiation light is preferably from 680 to 900 nm, more preferably from 750 to 850 nm.

In this case, a difference (absolute value) between a wavelength of a rise point P of spectral sensitivity of the photoreceptor after formation of the surface layer and a maximum wavelength of color data-applying light is preferably 30 nm or more, more preferably 50 nm or more. Further, a difference (absolute value) between a peak wavelength in this spectral sensitivity and a maximum wavelength of color data-applying light is preferably 50 nm or more, more preferably 80 nm or more.

For obtaining the foregoing photoreceptor, light transmittance in the wavelength region below the point P of the surface layer is preferably 1% or less, more preferably 0.1% or less. Light transmittance in a saturated point Q of light absorption is preferably 50% or more, more preferably 80% or more.

Further, a wavelength difference (absolute value) between the points P and Q is preferably 200 nm or less.

For obtaining the foregoing photoreceptor, the spectral sensitivity of the photosensitive layer has to be provided, of course, in a wavelength region of at least the point P. In order for the photoreceptor to be usable as a photoreceptor having as high sensitivity as possible, the spectral sensitivity shown by the curve (c) is in the range of, preferably from 50 to 80%, more preferably from 80 to 100% relative to the overall spectral sensitivity shown by the curve (a).

As the method in which light is scattered or absorbed on the surface of the photoreceptor to adjust the spectral sensitivity as described above, a method may be used in which a surface layer containing a substance that allows absorption or scattering of light having a wavelength in a specific region is formed on the photosensitive layer or a substance that allows absorption or scattering of light having a wavelength in a specific region is incorporated into a charge-transporting layer of a layered photoreceptor.

As the method in which light of the wavelength in the specific region is absorbed, a method in which a dye or a pigment having absorption in the foregoing wavelength region is dissolved or dispersed in the surface layer or the like is desirable. The method in which light of the wavelength in the specific region is scattered may be realized by dispersing a light-scattering pigment on the surface layer or the like to allow scattering in the wavelength region.

(Photosensitive Layer)

The structure of the photoreceptor that satisfies the foregoing properties is specifically described below.

The photosensitive layer in the aspect of the invention is, for example, a photosensitive layer of an inorganic material such as Se or a-Si or a single-layer or multilayer organic photosensitive layer, which is formed on a conductive substrate. In a belt-like photoreceptor, a transparent resin such as PET or PC can be used as a substrate, and its thickness is determined from designing items such as a diameter and a tension of a roll on which to suspend the belt-like photoreceptor. It is approximately from 10 to 500 μm. The other layer structure and the like are the same as in a drum.

The photoreceptor 10 in this exemplary embodiment has a photosensitive layer formed on the substrate and a surface layer formed thereon as will be later described.

As the organic photosensitive layer, a layered photoreceptor of a structure having at least a charge-generating layer and a charge-transporting layer is general. With respect to the charge-generating layer and the charge-transporting layer in the layered organic photoreceptor, the following known materials and structures can be used.

—Charge-Generating Layer—

As a charge-generating material, inorganic photoconductors such as amorphous selenium, crystalline selenium, selenium-tellurium alloy, selenium-arsenic alloy, other selenium compounds and selenium alloys, amorphous silicon and cadmium sulfide, substances obtained by sensitizing these with dyes, and organic pigments and dyes such as various phthalocyanines, e.g., metal-free phthalocyanine, titanyl phthalocyanine, copper phthalocyanine, tin phthalocyanine and gallium phthalocyanine, naphthalocyanine pigment, squalium type, anthoanthrone type, perylene type, azo type, triazo type, anthraquinone type, pyrene type, pyrylium salt and thiapyrylium salt are used. These organic pigments have generally plural crystal forms. Especially, as phthalocyanine pigments, various crystal forms including α-form and β-form are known. Any of these crystal forms may be used so long as pigments can provide desired sensitivity and other properties to comply with purposes.

As the photosensitive layer, it is advisable to use a photosensitive layer having a peak of spectral sensitivity in the range of from 550 to 1,000 nm. From this standpoint, phthalocyanine pigments such as hydroxygallium phthalocyanine, titanyl phthalocyanine, copper phthalocyanine and metal-free phthalocyanine, and the like may be used as a charge-generating material.

Specific examples of a binder resin in the charge-generating layer can include a polycarbonate resin of bisphenol A type, bisphenol Z type or the like, a copolymer thereof, a polyarylate resin, a polyester resin, a methacrylic resin, an acrylic resin, a polyvinyl chloride resin, a polystyrene resin, a polyvinyl acetate resin, a styrene-butadiene copolymer resin, a vinylidene chloride-acrylonitrile copolymer resin, a vinyl chloride-vinyl acetate-maleic anhydride resin, a silicone resin, a silicone-alkyd resin, a phenol-formaldehyde resin, a styrene-alkyd resin, poly-N-vinylcarbazole and the like. These binder resins may be used either singly or in admixture of two or more thereof.

A mixing ratio (weight ratio) of the charge-generating material and the binder resin is preferably from 10:1 to 1:10. As a method in which the charge-generating material is dispersed in the resin, a method using a roll mill, a ball mill, a vibration ball mill, an attritor, a dino mill, a sand mill, a colloid mill or the like can be used.

A thickness of the charge-generating layer is set at, generally from 0.01 to 5 μm, preferably from 0.05 to 2.0 μm.

Since exposure for applying color data as will be later described is conducted at much higher intensity than that of exposure for ordinary latent image formation (an energy amount of light used in applying color data has to be approximately 1,000 times a value of exposure (2 mJ/m²) to a photoreceptor used in an ordinary electrophotographic process), photosensitivity of a charge-generating layer has been usually required to be 1/1000 that of ordinary photosensitivity for avoiding damage of the photoreceptor. However, this is unnecessary in the aspect of the invention, and the structure of the ordinary photosensitive layer can be used as such.

—Charge-Transporting Layer—

Examples of a charge-transporting material used in the charge-transporting layer include hole-transporting materials, for example, oxadiazole derivatives such as 2,5-bis(p-diethylaminophenyl)-1,3,4-oxadiazole; pyrazoline derivatives such as 1,3,5-triphenylpyrazoline and 1-[pyridyl-(2)]-3-(p-diethylaminostyryl)-5-(p-diethylaminostyryl)pyrazoline; aromatic tertiary amino compounds such as triphenylamine, tri(p-methyl)phenylamine, N,N-bis(3,4-dimethylphenyl)biphenyl-4-amine, dibenzylaniline and 9,9-dimethyl-N,N-di(p-tolyl)fluorenone-2-amine; aromatic tertiary diamino compounds such as N,N′-diphenyl-N,N′-bis(3-methylphenyl)-[1,1-biphenyl]-4,4′-diamine; 1,2,4-triazine derivatives such as 3-(4′-dimethylaminophenyl)-5,6-di-(4′-methoxyphenyl)-1,2,4-triazine; hydrazone derivatives such as 4-diethylaminobenzaldehyde-1,1-diphenylhydrazone, 4-diphenylaminobenzaldehyde-1,1-diphenylhydrazone, [p-(diethylamino)phenyl](1-naphthyl)phenylhydrazone, 1-pyrenediphenylhydrazone, 9-ethyl-3-[(2-methyl-1-indolynylimino)methyl]carbazole, 4-(2-methyl-1-indolynyliminomethyl)triphenylamine, 9-methyl-3-carbazole diphenylhydrazone, 1,1-di-(4,4′-methoxyphenyl)acrylaldehyde diphenylhydrazone and β,β-bis(methoxyphenyl)vinyldiphenylhydrazone; quinazoline derivatives such as 2-phenyl-4-styrylquinazoline; benzofuran derivatives such as 6-hydroxy-2,3-di(p-methoxyphenyl)benzofuran; α-stilbene derivatives such as p-(2,2-diphenylvinyl)-N,N-diphenylaniline; enamine derivatives; carbazole derivatives such as N-ethylcarbazole; and poly-N-vinylcarbazole and its derivatives,

electron-transporting materials, for example, quinoline compounds such as chloranil, bromanil and anthraquinone: tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole and 2,5-bis(4-naphthyl)-1,3,4-oxadiazole and 2,5-bis(4-diethylaminophenyl)-1,3,4-oxadiazole; xanthone compounds; thiophene compounds; diphenoquinone compounds such as 3,3′,5,5′-tetra-t-butyldiphenoquinone and 3,5-dimethyl-3′,5′-di-t-butyl-4,4′-diphenoquinone, polymers having groups made of the above-listed compounds in a main chain or a side chain, and the like.

These charge-transporting materials may be used either singly or in combination of two or more thereof.

In the layered photoreceptor, charge polarity of the photoreceptor varies with charge-transporting polarity of the charge-transporting material. When the hole-transporting material is used, the photoreceptor is used in a negative charge. When the electron-transporting material is used, the photoreceptor is used in a positive charge. When the two materials are mixed, the photoreceptor in an amphoteric charge can be provided.

As the binder resin used in the charge-transporting layer, any binder resin is available. Especially, a binder resin may have compatibility with the charge-transporting material and appropriate strength.

Examples of the binder resin include a polycarbonate resin of bisphenol A, bisphenol Z, bisphenol C, bisphenol TP or the like and a copolymer thereof, a polyarylate resin and a copolymer thereof, a polyester resin, a methacrylic resin, an acrylic resin, a polyvinyl chloride resin, a polyvinylidene chloride resin, a polystyrene resin, a polyvinyl acetate resin, a styrene-butadiene copolymer resin, a vinyl chloride-vinyl acetate copolymer resin, a vinyl chloride-vinyl acetate-maleic anhydride copolymer resin, a silicone resin, a silicone alkyd resin, a phenol-formaldehyde resin, a styrene-acrylic copolymer resin, a styrene-alkyd resin, a poly-N-vinylcarbazole resin, a polyvinyl butyral resin, a polyphenylene ether resin and the like. These resins may be used either singly or in admixture of two or more thereof.

A molecular weight of the polymer used in the aspect of the invention is properly selected according to film-forming conditions such as a film thickness of the photosensitive layer and a solvent. It is usually from 3,000 to 300,000, more preferably from 20,000 to 200,000 in terms of a viscosity average molecular weight.

In the aspect of the invention, as stated above, the photoreceptor can be designed such that the charge-transporting layer has a function of the surface layer as will be later described. In this case, a material to be added to the charge-transporting layer is the same as a material to be added to the surface layer as will be later described. Especially, a material which does not influence electrical properties such as charge transportability is selected. A mixing ratio (weight ratio) of this material and the binder resin is preferably from 0.0001:100 to 10:100.

When the photoreceptor is so designed, it is unnecessary to provide a surface layer separately. Accordingly, the charge-transporting layer becomes the surface layer in the aspect of the invention.

The charge-transporting layer can be formed by coating a solution obtained by dissolving the charge-transporting material, materials to be added as required and the binder resin in an appropriate solvent and drying the solution. As the solvent used to form the charge-transporting layer, aromatic hydrocarbons such as benzene, toluene and chlorobenzene, ketones such as acetone and 2-butanone, halogenated aliphatic hydrocarbons such as methylene chloride, chloroform and ethylene chloride, cyclic or linear ethers such as tetrahydrofuran, dioxane, ethylene glycol and diethyl ether, mixed solvents thereof and the like can be used.

A mixing ratio (weight ratio) of the charge-transporting material and the binder resin is preferably from 10:1 to 1:5. A film thickness of the charge-transporting layer is set at, generally from 5 to 50 μm, preferably from 10 to 40 μm.

For preventing deterioration of the photoreceptor with ozone or acidic gas generated in the apparatus or with light and heat, it is possible to add additives such as an antioxidant, a light stabilizer and a heat stabilizer to the photosensitive layer.

When the charge-transporting layer is used as the uppermost surface layer, it is also possible to incorporate releasable solid particles such as Teflon (registered trademark) in the charge-transporting layer for improving lubricity of the surface.

(Surface Layer)

In the photoreceptor according to an aspect of the invention, the surface layer having the foregoing function is formed on the surface of the photosensitive layer.

As the surface layer, a layer formed by dispersing in the binder resin a substance that absorbs or scatters the light of the wavelength in the specific region or a light-scattering pigment that scatters light in the specific wavelength region can be used. For example, when it is required to absorb light in a visible light region, a dye or a pigment made of one or more materials that absorb light in a wavelength region of from approximately 400 to 700 nm can be used.

Specifically, as a dye which absorbs light in a visible light region and is light-transmittable in a near-infrared region, black dyes such as Kaya Set Color Black A-N, Kaya Set Color Black G and Kaya Set Color Black B manufactured by Nippon Kayaku Co., Ltd., and Diaresin Black B manufactured by Mitsubishi Chemical Corp. can be mentioned as a single material.

Preferable examples of the binder resin include a fluororesin, a silicone or acrylic hard coating resin, a phenol resin, a urethane resin, a siloxane resin and the like, and a siloxane resin is more preferable. Especially, a resin having a crosslinked structure is preferable in view of strength, electrical properties, image quality retention and the like, and a resin containing a charge-transporting material is more preferable.

A mixing ratio (weight ratio) of the dye or the pigment and the binder resin is preferably from 0.01:99.99 to 5:95. As a method in which the dye or the pigment is dispersed in the resin, it is possible to employ a method using a roll mill, a ball mill, a vibration ball mill, an attritor, a dino mill, a sand mill, a colloid mill or the like.

A thickness of the surface layer is preferably from 0.1 to 10 μm, more preferably from 1 to 5 μm.

A known charging unit can be used to charge the thus-obtained photoreceptor 10. In case of a contact system, a roll, a brush, a magnetic brush, a blade or the like is available. In case of a non-contact system, corotron, scorotron or the like is available. The charging unit is not limited to these.

Of these, the contact charging unit is preferably used because an ability to compensate charge is excellent. In the contact charging system, the surface of the photoreceptor is charged by applying voltage to a conductive member in contact with the surface of the photoreceptor. The conductive member may have substantially a shape of a brush, a blade, a pin electrode, a roll or the like. Especially, a roll-shaped member is preferable. Usually, the roll-shaped member includes resistance layers, an elastic layer supporting them and a core which are arranged in this order as viewed from the outside. Further, a protective layer may be formed outside the resistance layers, as required.

The roll-shaped member is rotated at the same peripheral speed as that of the photoreceptor 10 by being brought into contact with the photoreceptor 10 without providing any driving unit, and serves as a charging unit. However, the roll-shaped member may be charged by being rotated at a different peripheral speed from that of the photoreceptor 10 by mounting some driving unit on the roll-shaped member. A material of the core is a conductive material, and iron, copper, brass, stainless steel, aluminum, nickel or the like is generally used. Further, a resin molded article having conductive particles dispersed therein or the like is also available.

A material of the elastic layer is a conductive or semiconductive material. A rubber material having dispersed therein conductive particles or semiconductive particles is generally available. As the rubber material, EPDM, polybutadiene, natural rubber, polyisobutylene, SBR, CR, NBR, silicone rubber, urethane rubber, epichlorohydrin rubber, SBS, thermoplastic elastomer, norbornene rubber, fluorosilicone rubber, ethylene oxide rubber and the like are used.

As the conductive particles or the semiconductive particles used to adjust resistance of the elastic layer, it is possible to use metals such as carbon black, zinc, aluminum, copper, iron, nickel, chromium and titanium; metal oxides such as ZnO—Al₂O₃, SnO₂—Sb₂O₃, In₂O₃—SnO₂, ZnO—TiO₂, MgO—Al₂O₃, FeO—TiO₂, TiO₂, SnO₂, Sb₂O₃, In₂O₃, ZnO and MgO; and the like. These materials may be used either singly or in admixture of two or more thereof.

As a material of the resistance layer and the protective layer, a material obtained by dispersing conductive particles or semiconductive particles in a binder resin to control the resistance may be used. Resistivity is from 10³ to 10¹⁴ Ωcm, preferably from 10⁵ to 10¹² Ωcm, more preferably from 10⁷ to 10¹² Ωcm. A film thickness thereof is from 0.01 to 1,000 μm, preferably from 0.1 to 500 μm, more preferably from 0.5 to 100 μm.

As the binder resin, an acrylic resin, a cellulose resin, a polyamide resin, a methoxymethylated nylon, an ethoxymethylated nylon, a polyurethane resin, a polycarbonate resin, a polyester resin, a polyethylene resin, a polyvinyl resin, a polyarylate resin, a polythiophene resin, polyolefin resins such as PFA, FEP and PETFE, a styrene-butadiene resin and the like are used. As the conductive particles or the semiconductive particles, the same carbon black, metals and metal oxides as in the elastic layer are used. Further, an antioxidant such as hindered phenol or hindered amine, and a filler such as clay or kaolin, and a lubricant such as silicon oil may be added as required.

As a method for forming these layers, a blade coating method, a Meyer bar coating method, a spray coating method, a dip-coating method, a bead coating method, an air knife coating method, a curtain coating method and the like are available.

As a method in which the photoreceptor 10 is charged with these conductive members, voltage is applied to the conductive members. As applied voltage, DC voltage or DC voltage superimposed with AC voltage may be used. With respect to the range of the voltage, the DC voltage is positive or negative according to the charge potential of the photoreceptor required, and it is preferably from 50 to 2,000 V, more preferably from 100 to 1,500 V, further preferably from 100 to 400 V. When the DC voltage is superimposed with the AC voltage, peak to peak voltage (Vpp) is from 400 to 1,800 V, preferably from 800 to 1,600 V, and a frequency of the AC voltage is from 50 to 20,000 Hz, preferably from 100 to 5,000 Hz. A sine wave, a square wave and a triangle wave are all available.

It is advisable that charge potential is set at the range of from 100 to 1,000 V in terms of an absolute value of potential.

A known exposure device 14 can be used to form the electrostatic latent image. As the exposure device 14, for example, a laser scanning system, a LED image bar system, an analog exposure unit, liquid crystal shutter light, an ion flow control head or the like can be used. As shown by an arrow A in FIG. 1, the surface of the photoreceptor 10 can be exposed to light. Further, new exposure units which will be explored in future may be used.

As the light source, a light source having a wavelength (wavelength of latent image-applying light) in a wavelength region in which the photoreceptor 10 has sensitivity is used. Specifically, it is advisable that latent image-forming light is in a wavelength region in which spectral sensitivity is 100 V·m²/mJ or more in the photoreceptor having the surface layer and the like formed thereon.

With respect to a wavelength of a semiconductor laser, near-infrared light having an oscillation wavelength at approximately 780 nm has been so far mainly used. However, a laser having an oscillation wavelength at a level of 600 nm or a blue laser having an oscillation wavelength at from approximately 400 to 450 nm may be used. A surface-luminescent laser light source of a type capable of multi-beam output is also effective for forming a color image.

The exposure of the photoreceptor 10 is conducted as a logic sum of the image-forming data of the four colors in a position of developing a toner to be later described in the reversal development and in a position except the position of developing the toner in the normal development. An exposure spot diameter may be from 10 to 240 μm such that resolution is from 100 to 2,400 dpi. It is advisable that an exposure value is so adjusted that potential after exposure is from 0 to 30% of the foregoing charge potential. However, when a developing amount of the toner is changed according to a gradation of an image, an exposure value may be changed according to a developing amount for each exposure position.

<Development>

A known developing device 16 can be used to develop the electrostatic latent image. As the developing method, a two-component developing method using two components, i.e., fine particles for supporting a toner which are called a carrier and a toner, a one-component developing method using only a toner, and all other developing methods in which other substances may be added for improving developability or other properties in these developing methods may be used.

The developing method includes a method in which the development is conducted such that the developing agent is contacted with the photoreceptor 10, and a method in which the development is conducted such that the developing agent is not contacted with the photoreceptor 10 and a combination of the two methods, and these methods are all available. Further, a hybrid developing method is also available which is a combination of the one-component developing method and the two-component developing method. Besides these methods, new developing methods which will be explored in future can be used.

In the development, for example, the three types of the toners to which color data are applied by absorbing lights from the light sources of the three wavelengths are developed simultaneously. With respect to the toner contained in the developing agent, for example, a color formation part capable of forming a Y color (Y color formation part), a color formation part capable of forming an M color (M color formation part) and a color formation part capable of forming a C color (C color formation part) may be contained in one toner particle, or the Y color formation part, the M color formation part and the C color formation part may be contained separately in respective toners.

A toner developing amount (adhesion amount of a toner to be adhered to the photoreceptor) varies with an image to be formed. However, it is preferably from 3 to 15 g/m², more preferably from 5 to 12 g/m² in a solid image.

In a toner image T formed, light for applying color data to be later described has to be applied on an entire portion irradiated with light. It is therefore advisable to control the thickness of the toner layer below a prescribed value. Specifically, for example, in a solid image, the number of the toner layer is preferably 3 or less, more preferably 2 or less. The thickness of the toner layer is a value obtained by measuring the thickness of the toner layer formed on the surface of the actual photoreceptor 10 and dividing it by the number average particle size of the toner.

<Color Data Impartation>

Subsequently, with respect to the thus obtained toner T, color data is applied with light as shown by an arrow B to the toner image on the surface of the photoreceptor through the color data-applying device 28 as shown in FIG. 1. The position in which to impart color data as shown in FIG. 1 is one example, and the color data impartation may be conducted simultaneously with the development as will be described later.

The color data-applying device 28 is not particularly limited so long as light of a wavelength for forming a specific color of toner particles that undergo color formation at this time can be applied with predetermined resolution and intensity. For example, a LED image bar and a laser ROS are available. A irradiation spot diameter of light to be applied to the toner image T is adjusted to a range of, preferably from 10 to 240 μm, more preferably from 10 to 80 μm such that resolution of an image to be formed becomes from 100 to 2,400 dpi.

The wavelength of light to be applied for maintaining a color-forming state or a non-color-forming state is determined by designing of materials of the toner used. For example, in case of using a toner that allows color formation by applying light of a specific wavelength (light color formation-type toner), light of 405 nm (λ_{A} light) is applied in forming yellow (Y color), light of 535 nm (λ_{B} light) in forming magenta (M color), and light of 657 nm (λ_{C} light) in forming cyan (C color), to desired positions in which to form the respective colors.

In the aspect of the invention, the light source of the color data-applying unit is selected such that the light in the wavelength region for applying color data to the toner is scattered or absorbed on the surface of the photoreceptor. Specifically, it is advisable that light in a wavelength region in which transmittance is 0.1% or less is used as color data-applying light in the photoreceptor having the surface layer and the like formed thereon.

When a secondary color is formed, a combination of the lights is used. λ_{A} light and λ_{B} light are applied in forming red (R color), λ_{A} light and λ_{C} light in forming green (G color), and λ_{B} light and λ_{C} light in forming blue (B color), to respective desired positions for color formation. Further, λ_{A} light, λ_{B} light and λ_{C} light are applied in forming black (K color) as a tertiary color to a desired position for color formation by being overlaid.

When the foregoing results are summed up, the relation of the light of applying color data to the toner and the color to be formed is as shown in TABLE 1 (indicating that when encircled LED emits light, the toner forms a desired color).

TABLE 1

| Color to | | Y | M | C | R | G | B | K | W |
|---|---|---|---|---|---|---|---|---|---|
| be formed | | color | color | color | color | color | color | color | color |
| LED | 405 | ∘ | | | ∘ | ∘ | | ∘ | |
| wave- | nm | | | | | | | | |
| length | 532 | | ∘ | | ∘ | | ∘ | ∘ | |
| | nm | | | | | | | | |
| | 657 | | | ∘ | | ∘ | ∘ | ∘ | |
| | nm | | | | | | | | |

Meanwhile, in case of a toner that maintains a non-color-forming state by applying light of a specific wavelength (non-light-color-forming toner), for example, light of 405 nm (λ_{A} light) is applied in not forming yellow (Y color), light of 535 nm (λ_{B} light) in not forming magenta (M color) and light of 657 nm (λ_{C} light) in not forming cyan (C color), to respective desired positions in which to form the colors. Accordingly, λ_{B} light and λ_{C} light are applied in forming Y color, λ_{A} light and λ_{C} light in forming M color and λ_{A} light and λ_{B} light in forming C color, to respective desired positions for color formation.

When a secondary color is formed, the foregoing combinations of lights are used; λ_{C} light is applied in forming red (R color), λ_{B} light in forming green (G color) and λ_{A} light in forming blue (B color), to respective desired positions for color formation. Further, in forming black (K color) as a tertiary color, exposure is not conducted in a desired position for color formation.

When the foregoing results are summed up, a relation of color data-applying light applied to the toner and a color to be formed is as shown in TABLE 2 (indicating that when encircled LED emits light, a toner forms a desired color)

TABLE 2

| Color to | | Y | M | C | R | G | B | K | W |
|---|---|---|---|---|---|---|---|---|---|
| be formed | | color | color | color | color | color | color | color | color |
| LED | 405 | | ∘ | ∘ | | | ∘ | | ∘ |
| wave- | nm | | | | | | | | |
| length | 532 | ∘ | | ∘ | | ∘ | | | ∘ |
| | nm | | | | | | | | |
| | 657 | ∘ | ∘ | | ∘ | | | | ∘ |
| | nm | | | | | | | | |

When the toner forms (does not form) the B color, the G color and the R color in response to λ_{A} light, λ_{B} light and λ_{C} light by selecting dye materials used in the toner, the B color, the G color, the R color and the secondary colors thereof can be formed as shown in TABLES 1 and 2.

With respect to light from the color data-applying device 28, a known image modulation method such as pulse width modulation, intensity modulation or a combination of these two is available as required. An exposure value of light is preferably from 0.1 to 5 mJ/cm², more preferably from 0.5 to 5 mJ/cm². Especially regarding the exposure value, a necessary exposure value correlates with the amount of the toner developed. It is advisable to conduct exposure in the range of from 0.6 to 4 mJ/m² relative to approximately 5 g/m² of the developing amount (as a solid image) of the toner.

When the exposure light at this time is a laser beam, the laser beam has to be inclined usually at some degree (from 4 to 13 degree) in incidence of the laser beam into the photoreceptor in order to prevent light from returning to a monitor (photodetector) in the laser. Meanwhile, in the exposure of applying color data in the aspect of the invention, the returning light is absorbed on the toner. Therefore, the returning light is extremely reduced, and the exposure light can be incident at arbitrary angles including zero degree.

At what timing the exposure for applying the color data is conducted by what positional control is briefly described below.

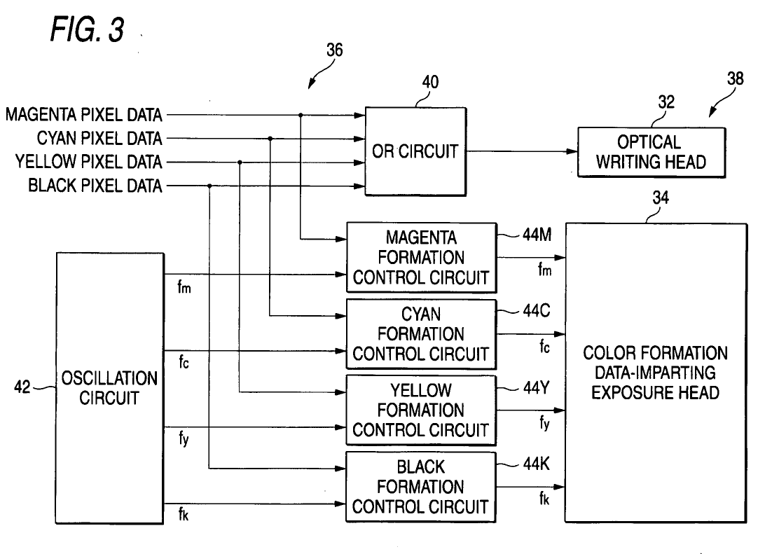

FIG. 3 shows a specific circuit block diagram of a printing controller in the image forming apparatus of the aspect of the invention. In the drawing, a printer controller 36 includes an OR circuit 40, an oscillation circuit 42, a magenta formation control circuit 44M, a cyan formation control circuit 44C, a yellow formation control circuit 44Y and a black formation control circuit 44K. On the other hand, an exposure part 38 includes an optical writing head 32 and a color data-applying exposure head 34.

Image data in which an RGB signals inputted are converted to CMYK values by an interface (I/F) not shown are inputted into the OR circuit 40 from the interface (I/F) as pixel data of magenta (M), cyan (C), yellow (Y) and black (K). The OR circuit 40 herein calculates a logic sum of CMYK and inputs it into the optical writing head 32.

That is, the data of the logic sum including all pixel data of CMYK is outputted to the optical writing head 32 to conduct the optical writing on the photoreceptor 10 as noted above. Accordingly, the electrostatic latent image based on the data of the logic sum including all pixel data of CMYK is formed on the peripheral surface of the photoreceptor 10.

The pixel data of CMYK are also supplied to the magenta formation control circuit 44M, the cyan formation control circuit 44C, the yellow formation control circuit 44Y and the black formation control circuit 44K, and outputted to the color data-applying exposure head 34 synchronously with oscillation signals fm, fc, fy and fk outputted from the oscillation circuit 42. That is, color data corresponding to magenta (M), cyan (C), yellow (Y) and black (K) respectively are supplied to the color data-applying exposure head 34, and light of a specific wavelength for maintaining a color-forming state or a non-color-forming state is applied correspondingly to the toner image T developed on the photoreceptor 10. Accordingly, a photo-curing reaction or the like to be later described takes place within the toner which receives applied light to impart color data.

For example, the color formation signal fm outputted from the magenta formation control circuit 44M applies the λ_{B} light to the color formation part of the toner to render the toner in a magenta (M) color-forming state. The color formation signal fc outputted from the cyan formation control circuit 44C applies the λ_{C} light to the color formation part of the toner to render the toner in a cyan (C) color-forming state. This is the same with yellow (Y) and black (K). The color formation signals fy and fk outputted from the yellow formation control circuit 44Y and the black formation control circuit 44K apply the λ_{A} light or the λ_{A} light, the λ_{B} light and the λ_{C} light to the color formation parts of the toner to render the toner in a yellow (Y) or black (K) color-forming state.

Regarding the procedure (unit) of applying the color data in the aspect of the invention, the mechanism in forming the full-color image has been described above. The procedure of applying the color data according to an aspect of the invention may be a procedure of applying color data for forming a mono-color image in which any of yellow, magenta and cyan is formed. In this case, only light of a specific wavelength corresponding to formation of a desired color among yellow, magenta and cyan is applied from the color data-applying exposure head 34. Other desirable conditions and the like are the same as those in forming the full-color image.

<Transfer>

The toner to which the color data has been applied is then transferred onto the recording medium 26 at a time. In the transferring, a known transferring device 18 can be used. For example, in a contact system, a roll, a brush, a blade and the like can be used. In a non-contact system, corotron, scorotron, pin corotron and the like can be used. Further, the transferring is possible with pressure or pressure and heat.

A transfer bias may be in the range of from 300 to 1,000 V (absolute value), and it may be superimposed with alternating current (Vpp: from 400 V to 4 kV, from 400 to 3 kHz).

<Fixation and Color Formation>

The toner image which has been rendered in the color-forming (non-color-forming) state undergoes color formation, as described above, by heating the recording medium 26 with the fixing device 22 (fixation and color formation). Specifically, the fixing device 22 has an ordinary electrophotographic toner-fixing function that the toner with the color data applied is heat-fused to fix the toner particles on the recording medium 26, and further a function that heat is applied to the toner to proceed with a reaction of color formation in the toner and form a color of the toner.

As the fixing device 22, a known fixing unit can be used. For example, a roll and a belt can be selected as a heating member and a pressing member respectively. A non-contact fixing device such as an oven fixing unit may also be employed. As a heat source, a halogen lamp, IH and the like are available. Its location may be adapted to various paper paths such as a straight path, a rear C path, a front C path, an S path and a side C path.

In the image forming apparatus shown in FIG. 1, the fixing device 22, as noted above, serves as the color formation unit and the fixing unit. However, the color formation unit and the fixing unit may be mounted separately. In this case, a position in which to locate the color formation device that conducts color formation is not particularly limited.

With respect to the color formation method, various methods have been considered according to color formation mechanisms of toner particles. As the color formation device (color formation unit), it is possible to use, for example, a device that emits specific light is used in a method in which color formation is conducted or limited by curing or optically decomposing color formation-participating materials in a toner further using lights different in wavelength, and a pressure device is used in a method in which color formation is conducted or limited by destroying encapsulated color-forming particles with pressure.

However, in such chemical reactions for color formation, a reaction rate by migration or diffusion is generally low. Accordingly, in any of these methods, a satisfactory diffusion energy has to be applied. In this respect, a method in which the reaction is accelerated by heating is said to be best. For this reason, it is advisable to use the fixing device 22 which serves as the color formation unit and the fixing unit.

<Other Steps>

It is advisable that the aspect of the invention further includes irradiating the image obtained after fixation and color formation with light. Since a reactive substance remaining in the color formation part controlled in a non-color-forming state can thereby be decomposed or deactivated, it is possible to suppress change in color balance after image formation more securely or to remove or bleach a background color.

In this exemplary embodiment, the light irradiation is adapted to be conducted after the fixation. However, in a fixing method without heat fusion, for example, in a pressure fixing method in which fixation is conducted with pressure, the fixation may be conducted after the light irradiation.

The light irradiation device 24 is not particularly limited so long as color formation of a toner can no longer proceed. Known lamps such as a fluorescent lump, LED and EL are available. Regarding the wavelength, it is advisable that lights for color formation of the toner have three wavelengths and illuminance is from 2,000 to 200,000 lux, and that the exposure time is from 0.5 to 60 sec.

In addition, the forgoing image forming method may include a known procedure used in an ordinary electrophotographic process which is practiced with a colorant such as a pigment. For example, it may include a cleaning step of cleaning a surface of an image support after transferring a toner image. As a cleaner 20, a known cleaner can be used. A blade, a brush and the like are available. Further, a cleaner-less process in which the cleaner 20 is removed may be employed.

Further, a transferring step may be an intermediate transferring method including a first transferring step of transferring the toner image from an image support to an intermediate transferring member such as an intermediate transferring belt and a second transferring step of transferring onto a recording medium the toner image transferred onto the intermediate transferring member.

<Toner to be Used>

The toner used in the aspect of the invention is described below.

The toner used in the aspect of the invention is a toner which is controlled such that a color-forming or non-color-forming state can be maintained by applying color data with light as noted above, and “applying color data with light” and “a color-forming or non-color-forming state can be maintained” are also as stated above.

The toner having the foregoing function includes various types. For example, the toner disclosed in JP-A-2003-330228 is particles obtained by dispersing and mixing in a toner resin plural microcapsules having capsule walls whose substance permeability is changed by receiving external stimulus, and one (each color dye precursor) of two reactive substances that cause a color formation reaction by being incorporated into the particles is contained in microcapsules and the other (developer) in the toner resin outside the microcapsules.

In this toner, color formation is conducted by reacting the two types of reactive substances present inside and outside the capsules when applying light or ultrasonic wave using the cis-trans transition of a photoisomeric substance whose substance permeability is increased in applying light of a specific wavelength as a capsule wall.

Accordingly, when the toner of this structure is used, the cis-trans transition is a reversible reaction, and the transition from the trans state to the cis state therefore takes place with stimulus of light. Even when the developer slightly permeates the capsule wall, a satisfactory color formation reaction (color density) might not be obtained in color formation by heating when returning to the trans state during a printing process.

In the aspect of the invention, when the specific surface layer is formed on the surface of the photoreceptor as described above, the sensitivity of the photoreceptor is often decreased consequently. Thus, for satisfactorily forming the latent image with this sensitivity, a process speed has to be decreased in some cases. A tendency of a decrease in color formability accompanied by a reversible reaction when using the toner disclosed in JP-A-2003-330228 is increasingly observed especially when this process speed is decreased.

For this reason, in the aspect of the invention, it is advisable to use a toner (hereinafter sometimes referred to as an “F toner”) including a first component and a second component which are present in a spaced-apart relationship from each other and form a color when reacted with each other, and a photo-curing composition containing one of the first component and the second component, in which the photo-curing composition maintains a cured state or an uncured state by applying color data with light to control the reaction for color formation.

As will be later described, since a mechanism of applying color data to the toner is not a reversible reaction in the F toner, there is a merit that a time required until color formation by heating is not limited. Consequently, printing is possible even in a low speed region. Namely, the F toner can be applied to printing in a wide-ranging speed region. In addition, there is a merit that a degree of freedom is high in a location of a fixing unit and the like in which color formation is conducted by heating.

The color formation mechanism and the simple structure of the F toner are described below.

The F toner has, as will be later described, one or more continuous regions, called color formation part(s), capable of forming one specific color (or capable of maintaining a non-color-forming state) when applying color data to the binder resin with light.

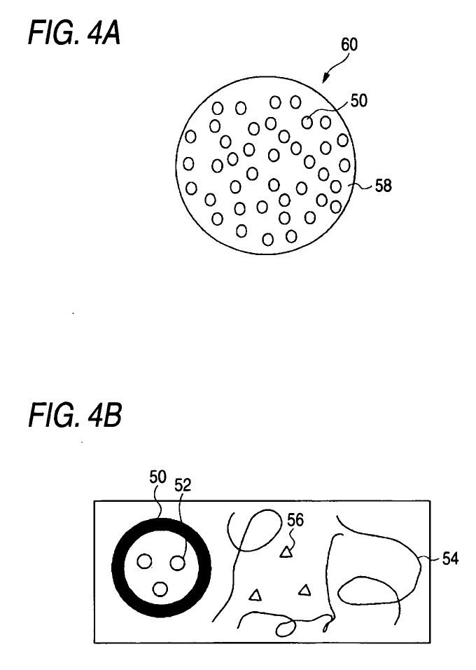

FIGS. 4A and 4B are schematic views showing one example of the color formation part in the F toner. FIG. 4A is a cross-sectional view of one color formation part, and FIG. 4B is an enlarged view of the color formation part.

As shown in FIG. 4A, the color formation part 60 includes color-forming microcapsules 50 containing various color formers and a composition 58 surrounding the microcapsules 50. As shown in FIG. 4B, the composition 58 contains a developer monomer (second component) 54 with a polymerizable functional group which allows color formation by being approached to or contacted with a color former (first component) 52 contained in the microcapsule 50, and a photopolymerization initiator 56.

In the color formation part 60 constituting the toner particles, the color former 52 filled in the color-forming microcapsules 50 may be a triaryl-type leuco compound excellent in sharpness of a color hue or the like. The developer monomer 54 that allows color formation of the leuco compound (electron-donating) may be an electron-accepting compound. Especially, a phenol compound is generally used, and it can properly be selected from developers which are used in heat-sensitive and pressure-sensitive paper and the like. The electron-donating color former 52 and the electron-accepting developer monomer 54 are subjected to an acid-base reaction to allow color formation of the color former.

As the photopolymerization initiator 56, a spectral sensitization dye is used which is sensitized with visible light to generate a polymerizable radical as a trigger for polymerizing the developer monomer 54. For example, a reaction accelerator of the photopolymerization initiator 56 is used in order that the developer monomer 54 can conduct a satisfactory polymerization reaction to exposure of basic three colors such as R color, G color and B color. For example, the spectral sensitization dye is optically excited by exposure using an ion complex made of a spectral sensitization dye (cation) absorbing exposure light and a boron compound (anion) to transfer an electron to the boron compound, with the result that a polymerizable radical is generated to start the polymerization.

By combining these materials, color formation recording sensitivity of from 0.1 to 0.2 mJ/cm² can be obtained in the photosensitive color formation part 60.

Some color formation part 60 having the polymerized developer compound and the unpolymerized developer monomer 54 is present depending on the presence or absence of light irradiation for applying color data to the color formation part 60 having the foregoing structure. In the color formation part 60 having the unpolymerized developer monomer 54, the developer monomer 54 migrates with heat or the like by the color formation device with subsequent heating or the like, passes through holes of partition walls of the color former microcapsules 50 and is diffused into the color former microcapsules. Regarding the developer monomer 54 and the color former 52 diffused into the microcapsules 50, the color former 52 is basic, and the developer monomer 54 is acidic as described above. Thus, the color former 52 allows color formation by the acid-base reaction.

Meanwhile, the developer compound that causes the polymerization reaction cannot be diffused and passed through the holes of the partition walls of the microcapsules 50 in the subsequent color formation by heating or the like due to bulkiness provided by the polymerization, and it cannot be reacted with the color former 52 of the color-forming microcapsules. Thus, no color formation can take place. Accordingly, the color-forming microcapsules 50 remain colorless. That is, the color formation part 60 irradiated with light of the specific wavelength exists without color formation.

After the color formation, the whole surface is exposed again to a white light source at an appropriate stage, whereby the developer monomer 54 that remains unpolymerized is all polymerized to conduct stable image fixation and a background color is erased by decomposing the residual spectral sensitization dye. Regarding the spectral sensitization dye of the photopolymerization initiator 56 corresponding to the visible light region, its color tone remains to the last as a background color. However, the color of this spectral sensitization dye can be erased using a light color erasing phenomenon of a color/boron compound. That is, a polymerizable radical is generated by transferring an electron from the optically excited spectral sensitization dye to the boron compound. While this radical causes polymerization of the monomer, it is reacted with an excited dye radical to decompose the color of the dye, making it possible to erase the color of the dye.

In the F toner, the color formation part 60 that forms the different colors in this manner (for example, forms Y color, M color and C color) can be made and used as one microcapsule in which each developer monomer 54 does not interfere with a color former other than the desired color former 52 (in a spaced-apart relationship from each other). In this F toner, the space other than the microcapsule containing the electron-donating color former is filled with the electron-accepting developer and the photo-curing composition, and the color formation part having this structure receives light. Thus, light receiving efficiency of one toner particle is overwhelmingly higher than that of the toner disclosed in JP-A-2003-330228. Accordingly, the effect of the back exposure can satisfactorily be exhibited in comparison to other toners.

Since the mechanism of applying color data is not a reversible reaction as stated above, there is a merit that a time required until color formation by heating is not limited. Accordingly, printing is possible even in a low speed region. That is, the F toner can be applied to printing in a wide-ranging speed region. In addition, there is a merit that a degree of freedom is high in a location of a fixing unit and the like in which color formation is conducted by heating.

The structure of the F toner is described in more detail below.

The F toner contains the first component and the second component which are present in a spaced-apart relationship from each other as a color-forming substance and which allow color formation when reacted with each other. Thus, color formation is conducted using the reaction of two types of the reactive components to make easy the control of the color formation. The first and second components may be colored in advance before color formation. However, it is especially desirable that these components are substantially colorless substances.

For making easy the control of color formation, two types of the reactive components that allow color formation when reacted with each other are used as color-forming substances. When these reactive components are present in the same matrix in which diffusion of substances is easily conducted even if there is no applying color data with light, color formation might proceed spontaneously in storage or production of a toner.

Accordingly, it is required that the reactive components are contained in different matrixes in which substances are not diffused in the mutual regions unless applying color data to the respective types (they are spaced apart from each other).

In order to inhibit diffusion of substances while not applying color data with light and prevent spontaneous color formation in storage or production of the toner, it is advisable that the first component of the two reactive components is contained in a first matrix, the second component is contained in another matrix (second matrix), and a partition wall in which diffusion of the substances between the first and second matrixes is inhibited and diffusion of the substances between the first and second matrixes is enabled in applying external stimulus such as heat according to the type of stimulus, intensity and combination is disposed between the first and second matrixes.

In order to locate the two types of reactive components in the toner using such a partition wall, it is advisable to use a microcapsule.

In this case, in the F toner, it is advisable that for example, the first component of the two reactive components is contained in the microcapsule and the second component outside the microcapsule. In this instance, the inside of the microcapsule corresponds to the first matrix and the outside of the microcapsule corresponds to the second matrix.

The microcapsule has a core and a shell that covers the core. This microcapsule is not particularly limited so long as it has a function that diffusion of substances inside or outside the microcapsule is inhibited unless applying external stimulus such as heat and diffusion of substances inside and outside the microcapsule is enabled according to the type of stimulus, intensity and combination when applying external stimulus. At least one of the reactive components is contained in the core.

Regarding the microcapsule, diffusion of substances inside or outside the microcapsule can be conducted by light irradiation or by exerting stimulus such as pressure. A heat-responsible microcapsule is especially desirable, and in this microcapsule, diffusion of substances inside and outside the microcapsule can be conducted by heat treatment (substance permeability of the shell is increased).

It is advisable that the diffusion of substances inside and outside the microcapsule when applying stimulus is irreversible in view of suppressing the decrease in color density at the time of image formation or inhibiting the change in color balance of an image which is allowed to stand under an atmosphere of high temperatures. Accordingly, it is advisable that the shell constituting the microcapsule has a function that substance permeability is irreversibly increased by softening, decomposition, dissolution (compatibility with surrounding members), deformation or the like owing to heat treatment or exertion of stimulus such as light irradiation.

A desirable structure of the F toner containing the microcapsule is described below.

It is advisable that the toner contains the first component and the second component which allow color formation when reacted with each other, the microcapsule and the photo-curing composition having the second component dispersed therein. Such a toner includes the following three exemplary embodiments.

That is, the F toner may be any one of an exemplary embodiment (first exemplary embodiment) that the toner contains the first and second components that allow color formation when reacted with each other, the photo-curing composition and the microcapsule dispersed in this photo-curing composition in which the first component is contained in the microcapsule and the second component is contained in the photo-curing composition, an exemplary embodiment (second exemplary embodiment) that the toner contains the first and second components that allow color formation when reacted with each other and the microcapsule containing the photo-curing composition, in which the first component is contained outside the microcapsule and the second component is contained in the photo-curing composition, and an exemplary embodiment (third exemplary embodiment) that the toner contains the first and second components that allow color formation when reacted with each other, one microcapsule containing the first component and the other microcapsule containing the photo-curing composition having the second component dispersed therein.

Of these three exemplary embodiments, the first exemplary embodiment is especially preferable in view of stability before applying color data with light, control of color formation and the like. The toner is described in more detail below mainly on the basis of the toner of the first exemplary embodiment. However, the structure, the materials, the process and the like of the toner as the first exemplary embodiment to be described below can of course be used in or applied to the toner of the second or third exemplary embodiment.

It is especially desirable that the F toner using a combination of the heat-responsible microcapsule and the photo-curing composition described above is any of the following two types.

(1) Toner of a type that even when the photo-curing composition is heat-treated in an uncured state, substance diffusion of the second component contained in the uncured photo-curing composition is suppressed and when the photo-curing composition is heat-treated after cured by irradiation with color data-applying light, substance diffusion of the second component contained in the photo-curing composition after curing is accelerated (hereinafter sometimes referred to as a “light-color-forming toner”).

(2) Toner of a type that when the photo-curing composition is heat-treated in an uncured state (state in which the second component is unpolymerized), substance diffusion of the second component contained in the uncured photo-curing composition is accelerated and when the photo-curing composition is heat-treated after cured by irradiation with color data-applying light (after the second component is polymerized), substance diffusion of the second component contained in the photo-curing composition after curing is suppressed (hereinafter sometimes referred to as a “non-light-color-forming toner”).

A main difference between the light-color-forming toner and the non-light-color-forming toner lies in materials constituting the photo-curing composition. In the light-color-forming toner, the photo-curing composition contains at least the second component (free from photopolymerizability) and the photopolymerizable compound, whereas in the non-light-color-forming toner, the photo-curing composition contains at least the second component having a photopolymerizable group in a molecule.

It is especially desirable that a photopolymerization initiator is contained in the photo-curing composition used in the light-color-forming toner and the non-light-color-forming toner. It may contain other materials as required.

As the photopolymerizable compound and the second component used in the light-color-forming toner, such materials are used that when the photo-curing composition is in an uncured state, the photopolymerizable compound and the second component interact with each other to suppress the substance diffusion of the second component in the photo-curing composition and the interaction therebetween is decreased after curing of the photo-curing composition (polymerization of the photopolymerizable compound) by irradiation with color data-applying light to make easy the diffusion of the second component in the photo-curing composition.

Accordingly, in the light-color-forming toner, when color data-applying light of a wavelength for curing the photo-curing composition is applied in advance before heat treatment (color formation), substance diffusion of the second component contained in the photo-curing composition becomes easy. Accordingly, at the time of heat treatment, the reaction (reaction of color formation) of the first component in the microcapsule and the second component in the photo-curing composition takes place by dissolution of the shell of the microcapsule or the like.

On the contrary, even when the photo-curing composition is heat-treated as such without applying the color data-applying light of the wavelength for curing the photo-curing composition, the second component is trapped in the photopolymerizable compound, so that it cannot be contacted with the first component in the microcapsule and the reaction (reaction of color formation) of the first and second components does not occur.

As has been described above, in the light-color-forming toner, the reaction (reaction of color formation) of the first and second components can be controlled by providing a combination of the presence or absence of irradiation with the color data-applying light of the wavelength for curing the photo-curing composition and the heat treatment, making it possible to control the color formation of the toner.

In the non-light-color-forming toner, the second component is itself photopolymerizable. Accordingly, even when the color data-applying light is applied, the substance diffusion of the second component contained in the photo-curing composition is kept easy unless this light has a wavelength for curing the photo-curing composition. Accordingly, when the heat treatment is conducted in this state, the reaction (reaction of color formation) of the first component in the microcapsule and the second component in the photo-curing composition takes place by dissolution of the shell of the microcapsule or the like.

Conversely, when color data-applying light of the wavelength for curing the photo-curing composition is applied before the heat treatment, the second components contained in the photo-curing composition are mutually polymerized to make difficult the substance diffusion of the second component contained in the photo-curing composition. Accordingly, even by the heat treatment, the second component cannot be brought into contact with the first component in the microcapsule, and the reaction (reaction of color formation) of the first and second components does not take place.

As stated above, in the non-light-color-forming toner, the reaction (reaction of color formation) of the first and second components can be controlled by providing a combination of the presence or absence of irradiation with color data-applying light of the wavelength for curing the photo-curing composition and the heat treatment, making it possible to control the color formation of the toner.

With respect to a desirable structure of the F toner, the toner containing the photo-curing composition and the microcapsule dispersed in the photo-curing composition is described in more detail below.

In this case, the toner may have only one color formation part containing the photo-curing composition and the microcapsule dispersed in the photo-curing composition. It is desirable that two or more color formation parts are provided in the toner. The “color formation part” here referred to means a continuous region capable of forming one specific color when the external stimulus is exerted as noted above.

When the toner has two or more color formation parts, only one type of the color formation parts capable of forming the same color may be contained in the toner. It is especially desirable that two or more types of the color formation parts capable of forming different colors are contained in the toner. The reason is that the formable color of one toner particle is limited to one type in the former case, whereas two or more types can be provided in the latter case.

For example, as two or more types of color formation parts capable of forming different colors, a combination including a yellow color formation part capable of forming a yellow color, a magenta color formation part capable of forming a magenta color and a cyan color formation part capable of forming a cyan color is mentioned.

In this case, for example, when only one type of the color formation parts allows color formation by applying external stimulus, the toner can form any one of yellow, magenta and cyan colors. When two types of the color formation parts allow color formation, a combination of colors formed by these two types of the color formation parts can be formed. Thus, one toner particle can express diversified colors.

When two or more types of the color formation parts capable of forming different colors are included in the toner, the formed colors can be controlled such that the color formation parts are different in types or combination of the first and second components contained in the respective color formation parts and also different in wavelength of light used for curing the photo-curing compositions contained in the respective color formation parts.

That is, in this case, since the wavelength of light required to cure the photo-curing composition contained in the color formation part varies depending on the type of the color formation part, plural types of color data-applying lights different in wavelength depending on the types of the color formation parts may be used as control stimulus. In order to provide different wavelengths of lights necessary for curing the photo-curing compositions contained in the color formation parts, photopolymerization initiators sensitive to lights of different wavelengths depending on the types of the color formation parts may be contained in the photo-curing compositions.

For example, when three types of color formation parts capable of forming yellow, magenta and cyan colors are included in the toner, materials which are cured in response to lights having wavelengths of 405 nm, 532 nm and 657 nm are used as the photo-curing compositions contained in the respective types of the color formation parts, so that the toner can form a desired color by selectively using color data-applying lights having these three different wavelengths (lights having specific wavelengths).

The wavelength of the color data-applying light can be selected from a wavelength in a visible region, but it may be selected from a wavelength in an ultraviolet region.

The toner used in the aspect of the invention may contain a matrix having as a main component the same binder resin as in an ordinary toner using a colorant such as a pigment. In this case, it is advisable that each of the two or more color formation parts is dispersed in the matrix as a particulate capsule (an encapsulated color formation part will sometimes be referred to hereinafter as a “photosensitive/heat-sensitive capsule”). Further, the matrix may contain a release agent and other additives similarly to the ordinary toner using a colorant such as a pigment.

The photosensitive/heat-sensitive capsule has a core containing a microcapsule or a photo-curing composition and a shell covering the core. This shell is not particularly limited so long as the microcapsule or the photo-curing composition in the photosensitive/heat-sensitive capsule can stably be retained without leaking outside the photosensitive/heat-sensitive capsule during production of the toner to be later described or during storage of the toner.

In the aspect of the invention, however, it is advisable that a binder resin made of a water-insoluble resin or a water-insoluble material such as a release agent is contained as a main component in order to prevent flow of the second component into the matrix outside the photosensitive/heat-sensitive capsule through the shell or inflow of the second component capable of forming another color in the photosensitive/heat-sensitive capsule through the shell during production of the toner to be later described.

The materials constituting the F toner, the materials and method used in preparing the materials constituting the toner and the like are described in more detail below.

In this case, it is especially desirable that at least the first component, the second component, the microcapsule containing the first component and the photo-curing composition containing the second component are used in the toner and the photopolymerization initiator is contained in the photo-curing composition. Various aids and the like may be contained. The first component may be present within the microcapsule (core) in a solid state, or may be present along with a solvent.

In the non-light-color-forming toner, an electron-donating colorless dye, a diazonium salt compound or the like is used as the first component, and a photopolymerizable group-containing electron-accepting compound, a photopolymerizable group-containing coupler compound or the like is used as the second component. In the light-color-forming toner, an electron-donating colorless dye is used as the first component, an electron-accepting compound (sometimes referred to as an “electron-accepting developer” or “developer”) as the second component, and a polymerizable compound having an ethylenic unsaturated bond as a photopolymerizable compound respectively.

In addition to the above-listed materials, the materials which are the same as materials constituting an ordinary toner using a colorant, such as a binder resin, a release agent, internal additives and external additives, can be used as required. The materials are described in more detail below.

—First Component and Second Component—

As a combination of the first component and the second component, the following combinations (a) to (r) may be listed (in the following examples, the former is the first component and the latter is the second component).

(a) a combination of an electron-donating colorless dye and an electron-accepting compound

(b) a combination of a diazonium salt compound and a coupling component (hereinafter referred to as a “coupler compound”)

(c) a combination of an organic acid metal salt such as silver behenate or silver stearate and a reducing agent such as protocatechuic acid, spiroindane or hydroquinone

(d) a combination of a long-chain fatty acid iron salt such as ferric stearate or ferric myristate and a phenol such as tannic acid, gallic acid or ammonium salicylate

(e) a combination of an organic acid heavy metal salt such as nickel, cobalt, lead, copper, iron, mercury or silver salt of acetic acid, stearic acid or palmitic acid and an alkali metal or alkaline earth metal sulfide such as calcium sulfide, strontium sulfide or potassium sulfide, or a combination of the organic acid heavy metal salt and an organic chelating agent such as s-diphenylcarbazide or diphenylcarbazone

(f) a combination of a heavy metal sulfate such as sulfate of silver, lead, mercury or sodium and a sulfur compound such as sodium tetrathionate, sodium thiosulfate or thiourea

(g) a combination of an aliphatic ferric salt such as ferric stearate and an aromatic polyhydroxy compound such as 3,4-hydroxytetraphenylmethane

(h) a combination of an organic acid metal salt such as silver oxalate or mercury oxalate and an organic polyhydroxy compound such as polyhydroxyalcohol, glycerin or glycol

(i) a combination of a fatty acid ferric salt such as ferric pelargonate or ferric laurate and a thiocetyl carbamide or isothiocetyl carbamide derivative

(j) a combination of an organic acid lead salt such as lead caproate, lead pelargonate or lead behenate and a thiourea derivative such as ethylenethiourea or N-dodecylthiourea

(k) a combination of a higher aliphatic heavy metal salt such as ferric stearate or copper stearate and zinc dialkyldithiocarbamate

(l) a combination of resorcin and a nitroso compound that forms an oxazine dye

(m) a combination of a formazan compound and a reducing agent and/or a metal salt

(n) a combination of a protected dye (or leuco dye) precursor and a deprotecting agent

(o) a combination of an oxidative color former and an oxidizer

(p) a combination of a phthalonitrile and a diiminoisoindoline (a combination that forms phthalocyanine)

(q) a combination of an isocyanate and a diiminoisoindoline (a combination that forms a coloring pigment)

(r) a combination of a pigment precursor and an acid or a base (a combination that forms a pigment).

Among the materials listed above as the first component, an electron-donating colorless dye or a diazonium compound which is substantially colorless is preferable.

As the electron-donating colorless dye, dyes which have been so far known can be used. Dyes that allow color formation by reaction with the second component are all available. Specific examples thereof can include compounds such as a phthalide compound, a fluoran compound, a phenothiazine compound, an indolylphthalide compound, a leucoauramine compound, a rhodamine lactam compound, a triphenylmethane compound, a triazene compound, a spiropyran compound, a pyridine compound, a pyrazine compound and a fluorene compound.

In case of the non-light-color-forming toner, the second component is a substantially colorless compound having in one molecule a photopolymerizable group and a site which allows color formation by reaction with the first component. Compounds that have two functions of allowing color formation by reaction with the first component and conducting polymerization by reaction with light for curing, such as photopolymerizable group-containing electron-accepting compounds and photopolymerizable group-containing coupler compounds, can all be used.

As the photopolymerizable group-containing electron-accepting compounds, namely the compounds having the electron-accepting group and the photopolymerizable group in one molecule, compounds having the photopolymerizable group and capable of allowing color formation by reaction with the electron-donating colorless dye as the first component and conducting photopolymerization for curing can all be used.

In case of the light-color-forming toner, examples of the electron-accepting developer as the second component include phenol derivatives, sulfur-containing phenol derivatives, organic carboxylic acid derivatives (for example, salicylic acid, stearic acid and resorcinic acid), metal salts thereof, sulfonic acid derivatives, urea or thiourea derivatives, acid clay, bentonite, a novolak resin, a metal-treated novolak resin, a metal complex and the like.

In the light-color-forming toner, a polymerizable compound having an ethylenic unsaturated bond is used as a photopolymerizable compound, and it includes polymerizable compounds having at least one ethylenic unsaturated double bond in a molecule, such as acrylic acid, its salts, acrylic acid esters and acrylamides.

The photopolymerization initiator is described below. The photopolymerization initiator can generate a radical by irradiation with color data-applying light to cause a polymerization reaction in the photo-curing composition and accelerate this reaction. The photo-curing composition is cured by this polymerization reaction.

The photopolymerization initiator can properly be selected from known products. Of these, a product containing a spectral sensitization compound having a maximum absorption wavelength at from 300 to 1,000 nm and a compound interacting with the spectral sensitization compound is preferable.

However, when the compound interacting with the spectral sensitization compound is a compound containing both of a dye portion having a maximum absorption wavelength at from 300 to 1,000 nm and a borate portion in the structure, it is unnecessary to use the spectral sensitization dye.

As the compound interacting with the spectral sensitization compound, it is possible to selectively use one or more of known compounds capable of starting a photopolymerization reaction with the photopolymerizable group of the second component as required.

When this compound coexists with the spectral sensitization compound, it is sensitively responsible to irradiation light in the spectral absorption wavelength region to be able to generate a radical at high efficiency. Consequently, high sensitivity is provided, making it possible to control generation of a radical using an arbitrary light source in a ultraviolet to infrared region.

As the “compound interacting with the spectral sensitization compound”, organic borate salt compounds, benzoin ethers, S-triazine derivatives having a trihalogen-substituted methyl group, organic peroxides and azinium salt compounds are preferable, and organic borate salt compounds are more preferable. When the “compound interacting with the spectral sensitization compound” is used in combination with the spectral sensitization compound, a radical can effectively be generated locally in a part exposed to light and high sensitivity can be attained.

For accelerating the polymerization reaction, an oxygen scavenger, a reducing agent such as a chain transfer agent of an active hydrogen donor and other compounds that accelerate polymerization in a chain transfer manner may further be added to the photo-curing composition as aids.

Examples of the oxygen scavenger include phosphine, phosphonate, phosphite, aurous salt and other compounds which are easily oxidized with oxygen. Specific examples thereof include N-phenylglycine, trimethylbarbituric acid, N,N-dimethyl-2,6-diisopropylaniline and N,N,N-2,4,6-pentamethylanilinic acid. Further, thiols, thioketones, trihalomethyl compounds, lophine dimer compounds, iodonium salts, sulfonium salts, azinium salts, organic peroxides, azides and the like are also useful as the polymerization accelerator.

In the F toner, the first component such as the electron-donating colorless dye or the diazonium salt compound is used by being encapsulated in a microcapsule.

As the encapsulation method, ordinary methods can be used. Examples thereof include a method using coacervation of a hydrophilic wall-forming material as described in U.S. Pat. Nos. 2,800,457 and 2,800,458, an interfacial polymerization method described in U.S. Pat. No. 3,287,154, British Patent No. 990,443, JP-B-38-19574, JP-B-42-446, JP-B-42-771 and the like, a method using polymer precipitation as described in U.S. Pat. Nos. 3,418,250 and 3,660,304, a method using an isocyanate polyol wall material as described in U.S. Pat. No. 3,796,669, a method using an isocyanate wall material as described in U.S. Pat. No. 3,914,511, a method using a urea-formaldehyde or urea formaldehyde-resorcinol wall-forming material as described in U.S. Pat. Nos. 4,001,140, 4,087,376 and 4,089,802, a method using a wall-forming material such as a melamine-formaldehyde resin or hydroxypropylcellulose as described in U.S. Pat. No. 4,025,455, an in-situ method by polymerization of a monomer as described in JP-B-36-9168 and JP-A-51-9079, an electrolytic dispersion cooling method described in British Patent Nos. 952,807 and 965,074, a spray-drying method described in U.S. Pat. No. 3,111,407 and British Patent No. 930,422, a method described in, JP-A-4-101885 and JP-A-9-263057, and the like.

The available material of the microcapsule wall is added to the inside and/or the outside of oil drops. Examples of the material of the microcapsule wall include polyurethane, polyurea, polyamide, polyester, polycarbonate, a urea-formaldehyde resin, a melamine resin, polystyrene, a styrene-methacrylate copolymer, a styrene-acrylate copolymer and the like. Of these, polyurethane, polyurea, polyamide, polyester and polycarbonate are preferable, and polyurethane and polyurea are more preferable. These polymeric substances may be used either singly or in combination of two or more thereof.

A volume average particle size of the microcapsule is adjusted to a range of, preferably from 0.1 to 3 μm, more preferably from 0.3 to 1.0 μm.

The photosensitive/heat-sensitive capsule may contain a binder, and this is the same with the toner having one color formation part.

As the binder, it is possible to use the same binders as in emulsification dispersion of the photo-curing composition and water-soluble polymers used in encapsulating the first reactive substance, as well as polystyrene, polyvinylformal, polyvinyl butyral, acrylic resins such as polymethyl acrylate, polybutyl acrylate, polymethyl methacrylate, polybutyl methacrylate and copolymers thereof, solvent-soluble polymers such as a phenol resin, a styrene-butadiene resin, ethylcellulose, an epoxy resin and an urethane resin, and polymeric latexes thereof. Of these, gelatin and polyvinyl alcohol are preferable. Further, binder resins to be later described may be used as a binder.

In the F toner, a binder resin which is used in an ordinary toner can be used. For example, in a toner having a structure that photosensitive/heat-sensitive capsules are dispersed in a matrix, the binder resin can be used as a main component constituting the matrix or a material constituting the shell of the photosensitive/heat-sensitive capsule. However, it is not critical.

The binder resin is not particularly limited, and a known crystalline or amorphous resin material can be used. Especially for applying low-temperature fixability, a crystalline polyester resin having sharp melt property is useful. As the amorphous polymer (amorphous resin), known resin materials such as a styrene-acrylic resin and a polyester resin are available. An amorphous polyester resin is especially preferable.

The F toner may further contain components other than the foregoing components. The other components are not particularly limited, and may properly be selected according to the purpose. Examples thereof include various known additives used in the ordinary toner, such as a release agent, inorganic fine particles, organic fine particles and a charge control agent.

A process for producing the F toner is briefly described below.

It is advisable to produce the F toner using a known wet process such as an aggregation coalescence process. Especially, the wet process may be used to produce a toner containing the first component and the second component which allow color formation when reacted with each other, the photo-curing composition and the microcapsule dispersed in the photo-curing composition in which the first component is contained in the microcapsule and the second component in the photo-curing composition.

It is especially desirable that the microcapsule used in the toner having the foregoing structure is a heat-responsible microcapsule. However, a microcapsule responsible to other stimulus such as light is also available.

In the production of the toner, known wet processes can be used. It is especially desirable to use, among known wet processes, an aggregation coalescence process because a maximum process temperature can be lowered and toners having various structures are easily produced.

In comparison to ordinary toners made mainly of a pigment and a binder resin, the toner having the foregoing structure contains a large amount of the photo-curing composition made mainly of a low-molecular component, and strength of particles obtained during pulverization of the toner therefore tends to be unsatisfactory. However, the aggregation coalescence process does not require high shearing force. In this respect as well, it is desirable to use the aggregation coalescence process.

Generally, the aggregation coalescence process includes an aggregation step of preparing dispersions of materials constituting the toner and forming aggregated particles in a starting dispersion obtained by mixing two or more of the dispersions, and a fusion step of fusing the aggregated particles formed in the starting dispersion, and an adhesion step (step of forming a coating layer) of adhering a component constituting a coating layer to surfaces of the aggregated particles to form the coating layer is conducted, as required, between the aggregation step and the fusion step.

The F toner can also be produced by a combination of the aggregation step, the fusion step and, as required, the adhesion step, though the types of the dispersions used as starting materials or the combination thereof is different.

For example, in case of a toner having a photosensitive/heat-sensitive capsule dispersion structure in a resin, first, one or more photosensitive/heat-sensitive capsule dispersions capable of forming mutually different colors is (are) prepared by (a1) a first aggregation step of forming first aggregated particles in a starting dispersion containing a microcapsule dispersion having dispersed therein microcapsules containing the first component and a photo-curing composition dispersion having dispersed therein the photo-curing composition containing the second component, (b1) an adhesion step of adding a first resin particle dispersion having the resin particles dispersed therein to the starting dispersion having the first aggregated particles formed therein to adhere the resin particles to the surfaces of the aggregated particles and (c1) a first fusion step of heating the starting dispersion containing the aggregated particles having the resin particles adhered to their surfaces to fuse the particles and obtain first fused particles (photosensitive/heat-sensitive capsules).

Subsequently, a toner having a photosensitive/heat-sensitive capsule dispersion structure can be obtained by (d1) a second aggregation step of forming second aggregated particles in a mixed solution obtained by mixing the one or more photosensitive/heat-sensitive capsule dispersions with the second resin particle dispersion having the resin particles dispersed therein and (e1) a second fusion step of heating the mixed solution containing the second aggregated particles to obtain second fused particles.

The types of the photosensitive/heat-sensitive capsule dispersions used in the second aggregation step may be two or more types. Further, the photosensitive/heat-sensitive capsules obtained by the steps (a1) to (c1) may directly be used as a toner (namely a toner having only one color formation part).

When the toner having only one color formation part is produced, it is also possible to conduct, instead of the foregoing adhesion step, a first adhesion step of adding a release agent dispersion having a release agent dispersed therein to the starting dispersion having the first aggregated particles formed therein to adhere the release agent to the surfaces of the aggregated particles and a second adhesion step of adding the first resin particle dispersion having the resin particles dispersed therein to the starting dispersion after the first adhesion step to adhere the resin particles to the surfaces of the aggregated particles having the release agent adhered thereto.

The volume average particle size of the F toner which can be used in the aspect of the invention is not particularly limited, and it can properly be adjusted according to the structure of the toner or the type and the number of the color formation parts included in the toner.

However, when the number of the types of the color formation parts capable of forming mutually different colors, which are included in the toner, is from approximately 2 to 4 (for example, a toner includes three types of color formation parts capable of forming yellow, cyan and magenta colors), it is desirable that a volume average particle size corresponding to each toner structure is within the following range.

That is, when the structure of the toner is a photosensitive/heat-sensitive capsule (color formation part) dispersion structure in the resin, the volume average particle size of the toner is preferably from 5 to 40 μm, more preferably from 10 to 20 μm. The volume average particle size of the photosensitive/heat-sensitive capsule contained in the toner of the photosensitive/heat-sensitive capsule dispersion structure having such a particle size is preferably from 1 to 5 μm, more preferably from 1 to 3 μm.

When the volume average particle size of the toner is less than 5 μm, the amount of the color-forming component contained in the toner is decreased, so that color reproducibility might be worsened or image density might be decreased. When the volume average particle size exceeds 40 μm, irregularity of the image surface might be increased or unevenness of gloss on the image surface might occur.

The toner of the photosensitive/heat-sensitive capsule dispersion structure having plural photosensitive/heat-sensitive capsules dispersed therein tends to be increased in particle size in comparison to an ordinary toner of a small size (volume average particle size—from 5 to 10 μm) using a colorant. However, since resolution of an image is determined not by the particle size of the toner but by the particle size of the photosensitive/heat-sensitive capsule, a more precise image can be obtained, and powder fluidity is also excellent. Accordingly, even though amounts of external additives are small, satisfactory fluidity can be secured, and developability or cleanability can also be improved.

Meanwhile, in case of the toner having only one color formation part, reduction in size is easier than in the foregoing case, and the volume average particle size thereof is preferably from 3 to 8 μm, more preferably from 4 to 7 μm. When the volume average particle size is less than 3 μm, the particle size is too small, and no satisfactory powder fluidity might be obtained or no satisfactory durability might be obtained. When the volume average particle size exceeds 8 μm, no high-precision image might be obtained.

In the aspect of the invention, the F toner described above and toners which are controlled to maintain a color-forming state or a non-color-forming state by light irradiation (or without light irradiation) can be used irrespective of the materials used, the structure of the toner, the color formation mechanism and the like.

In the toner which can be used in the aspect of the invention, it is preferable that a volume average particle size distribution index GSDv is 1.30 or less and a volume average particle size distribution index GSDv to number average particle size distribution index GSDp ratio (GSDv/GSDp) is 0.95 or more.

It is more preferable that the volume average particle size distribution index GSDv is 1.25 or less and the volume average particle size distribution index GSDv to number average particle size distribution index GSDp ratio (GSDv/GSDp) is 0.97 or more.

When the volume average particle size distribution index GSDv exceeds 1.30, resolution of the image might be decreased. When the volume average particle size distribution index GSDv to number average particle size distribution index GSDp ratio (GSDv/GSDp) is less than 0.95, chargeability of the toner might be decreased, or scattering of the toner, fogging or the like might occur to invite a defective image.

In the aspect of the invention, the volume average particle size, the volume average particle size distribution index GSDv and the number average particle size distribution index GSDp of the toner are measured and calculated as follows.

First, in particle size ranges (channels) in which a particle size distribution of a toner measured with Coulter counter TAII (manufactured by Nikkaki), Multisizer II (manufactured by Nikkaki) or the like is divided, cumulative distributions on the volume and the number of respective toner particles are drown from the smaller particle side. A particle size at cumulation of 16% is defined as a volume average particle size D16v and a number average particle size D16p, and a particle size at cumulation of 50% is defined as a volume average particle size D50v and a number average particle size D50p. Likewise, a particle size at cumulation of 84% is defined as a volume average particle size D84v and a number average particle size D84p. At this time, a volume average particle size distribution index (GSDv) is defined as (D84v/D16v)^{1/2}, and a number average particle size distribution index (GSDp) is defined as (D84p/D16p)^{1/2}. The volume average particle size distribution index (GSDv) and the number average particle size distribution index (GSDp) can be calculated using these relational expressions.

The volume average particle size of the microcapsule or the photosensitive/heat-sensitive capsule can be measured using, for example, a laser diffraction particle size distribution measuring apparatus (LA-700, manufactured by Horiba Ltd.).

In the toner according to an aspect of the invention, it is desirable that a shape factor SF1 represented by the following formula (1) is from 110 to 130.

SF1=(ML²/A)×(π/4)×100 (1)

wherein ML represents a maximum length (μm) of a toner, and A represents a projection area (μm²) of a toner.

When the shape factor SF1 is less than 110, the toner is liable to remain on the surface of the image support in transferring at the time of image formation. Thus, the residual toner has to be removed. Cleanability in cleaning the residual toner with a blade or the like tends to be decreased, with the result that a defective image might be formed.

Meanwhile, when the shape factor SF1 exceeds 130, the toner might be destroyed by being stricken against a carrier in a developing unit in case of using the toner as a developing agent. In this case, a fine powder might consequently be increased, whereby an image support surface or the like might be contaminated with a release agent component exposed to the toner surface to impair charging properties and further a problem of causing fog due to the fine powder might arise.

The shape factor SF1 is measured as follows using a Luzex image analyzer (FT, manufactured by Nireco Corporation). First, an optical microscope image of toners scattered on a slide glass is taken into a Luzex image analyzer through a video camera. Regarding 50 toners or more, a maximum length (ML) and a projection area (A) are measured. A square of the maximum length and the projection area are calculated on each toner, and the shape factor SF1 is obtained from the foregoing formula (1).

<Developing Agent>

The toner used in the aspect of the invention may directly be used as a one-component developing agent. In the aspect of the invention, however, it is advisable to use the toner as a toner in a two-component developing agent made of a carrier and a toner.

In view of the fact that a color image can be formed with one type of a developing agent, it is advisable that the developing agent is (1) a developing agent of a type which contains one type of a toner having two or more types of color formation parts each containing the photo-curing composition and the microcapsules dispersed in the photo-curing composition, the two or more types of color formation parts contained in the toner being capable of forming mutually different colors, or (2) a developing agent of a type which contains two or more types of toners, in a mixed state, each having one color formation part containing the photo-curing composition and the microcapsules dispersed in the photo-curing composition, the color formation parts of two or more types of toners being capable of forming mutually different colors.

For example, in the developing agent of the former type, it is desirable that three types of the color formation parts are included in the toner and they are a yellow color formation part capable of forming a yellow color, a magenta color formation part capable of forming a magenta color and a cyan color formation part capable of forming a cyan color. In the developing agent of the latter type, it is desirable that a yellow color-forming toner in which a color formation part is capable of forming a yellow color, a magenta color-forming toner in which a color formation part is capable of forming a magenta color and a cyan color-forming toner in which a color formation part is capable of forming a cyan color are contained in the developing agent in a mixed state.

As the carrier which can be used in the two-component developing agent, a carrier formed by coating a resin on a surface of a core is desirable. The core of the carrier is not particularly limited so long as the foregoing condition is satisfied. Examples thereof include magnetic metals such as iron, steel, nickel and cobalt, alloys of these metals with manganese, chromium, rare earth metals and the like, magnetic oxides such as ferrite and magnetite, and so forth. In view of the surface property of the core and the core resistance, ferrite is preferable, and alloys with manganese, lithium, strontium, magnesium and the like are preferable.

The resin which is coated on the surface of the core is not particularly limited so long as it can be used as a matrix resin. The resin can properly be selected according to the purpose.

In the two-component developing agent, the mixing ratio (weight ratio) of the toner according to an aspect of the invention and the above carrier is preferably from 1:100 to 30:100, more preferably from 3:100 to 20:100.

### EXAMPLES

The aspect of the invention is illustrated more specifically by referring to EXAMPLES. However, the invention is not limited to the following EXAMPLES.

<Production of Photoreceptors>

Photoreceptors used in the following EXAMPLE and COMPARATIVE EXAMPLE are described below along with processes for producing the same.

(Photoreceptor A)

—Undercoat Layer—

100 parts by weight of zinc oxide (average particle size: 70 nm, manufactured by TAYCA CORPORATION) is mixed with 500 parts by weight of tetrahydrofuran with stirring, and 1.25 parts by weight of a silane coupling agent (KBM603, manufactured by Shin-etsu Chemical Industry Co., Ltd.) is added thereto. The mixture is stirred for 2 hours. Subsequently, toluene is distilled off by vacuum distillation, and the residue is baked at 120° C. for 3 hours to obtain a zinc oxide pigment surface-treated with the silane coupling agent.

| | | |
|---|---|---|
| surface-treated zinc oxide pigment | 23 | parts by weight |
| butyral resin (BM-1, manufactured by Sekisui | 9 | parts by weight |
| Chemical Co., Ltd.) | | |
| blocked isocyanate (Sumidur 3175, manufactured | 12 | parts by weight |
| by Sumitomo Bayern Urethane) | | |
| silicone resin particles (Tospearl 120, | 3 | parts by weight |
| manufactured by Toshiba Silicone) | | |
| silicone oil (SH29PA, manufactured by Toray | 0.01 | part by weight |
| Dow Corning Silicone) | | |
| n-butanol | 80 | parts by weight |

The foregoing components are mixed, and dispersed with a sand mill for 2 hours to obtain a dispersion.

An aluminum substrate having a diameter of 30 mm, a length of 340 mm and a thickness of 1 mm is used as a support. The dispersion is coated on the substrate by dip coating, and the coated substrate is dried and cured at 150° C. for 30 minutes to form a coated film (undercoat layer) having a film thickness of 20 μm.

Vickers hardness of the undercoat layer is measured with a Vickers hardness tester ASAHI VL101 by exerting a load of 50 g. Consequently, the hardness is 40.

—Charge-Generating Layer—

Subsequently, a mixture containing 15 parts by weight of hydroxygallium phthalocyanine typified by a crystal form having at least a diffraction peak at a Bragg angle (2θ±0.2°) of 7.5°, 9.9°, 12.5°, 16.3°, 18.6°, 25.1° and 28.1° in x-ray diffraction spectrum using CuKα rays as a charge-generating substance, 10 parts by weight of a vinyl chloride-vinyl acetate copolymer resin (VMCH, manufactured by Nippon Unicar) as a binder resin and 300 parts by weight of n-butyl alcohol are dispersed with a sand mill for 4 hours. The resulting dispersion is dip-coated on the undercoat layer as a coating solution for a charge-generating layer, and dried to form a charge-generating layer having a thickness of 0.2 μm.

—Charge-Transporting Layer—

Further, 4 parts by weight of N,N′-diphenyl-N,N′-bis(3-methylphenyl)-[1,1′]biphenyl-4,4′-diamine and 6 parts by weight of a bisphenol Z polycarbonate resin (viscosity average molecular weight: 40,000) are dissolved in 80 parts by weight of chlorobenzene to form a coating solution. This coating solution is dip-coated on the charge-generating layer, and dried at 130° C. for 40 minutes to form a charge-transporting layer having a film thickness of 25 μm. This is designated a photoreceptor A.

(Photoreceptor B)

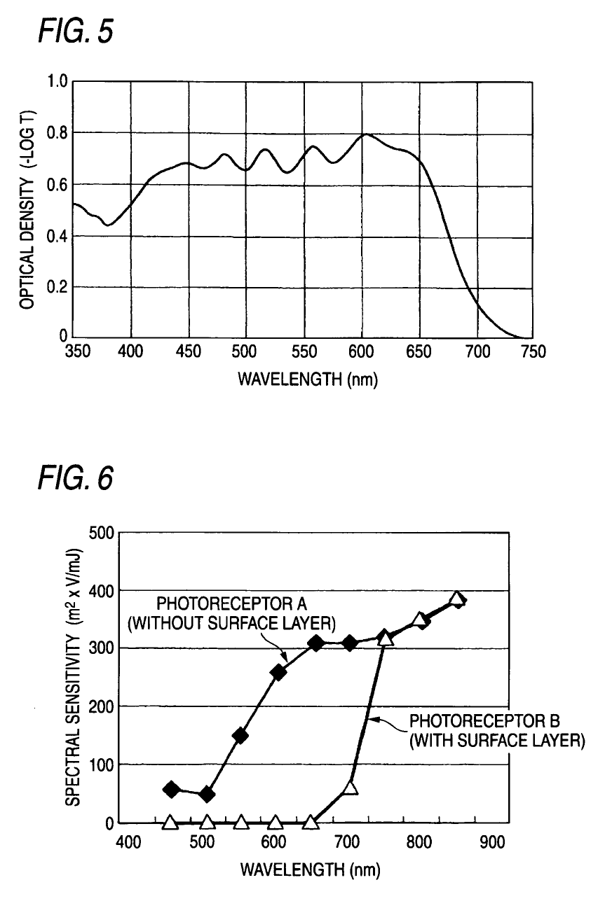

0.004 part by weight of a dye (Kayaset Black A-N, manufactured by Nippon Kayaku Co., Ltd.) showing an absorption spectrum (the ordinate represents a logarithm of absorbance T) in FIG. 5, 2 parts by weight of the following compound (I) and 2 parts by weight of the following compound (II) are dissolved in 5 parts by weight of isopropyl alcohol, 3 parts by weight of tetrahydrofuran and 3 parts by weight of distilled water, and 0.5 part by weight of an ion exchange resin is added. Hydrolysis is conducted at room temperature for 24 hours, and the ion exchange resin is separated by filtration. Then, 0.1 part by weight of trisacetylacetonatoaluminum and 0.4 part by weight of 3,5-t-butyl-4-hydroxytoluene (BHT) are added thereto to form a coating solution.

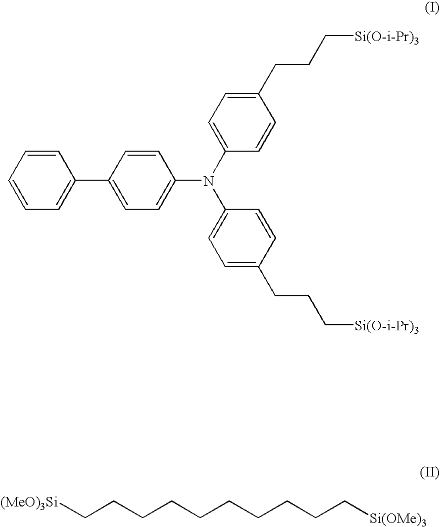

This coating solution is coated on the photosensitive layer of the photoreceptor A, and dried at 150° C. for 1 hour to obtain a surface layer having a film thickness of 3 μm. This is designated a photoreceptor B.

Spectral sensitivities of the resulting photoreceptors A and B are shown in FIG. 6. Transmittances at 405 nm, 535 nm and 657 nm of the surface layer alone which is formed using the coating solution are 0%, 0% and 0.01% respectively, and transmittance at 780 nm thereof is 96%.

### Example 1

(Toner)

First, the non-light-color-forming F toner in which a luminous part (photosensitive/heat-sensitive capsule) is dispersed in a binder resin is obtained in the following manner.

—Preparation of a Microcapsule Dispersion (1)—

8.9 parts by weight of an electron-donating colorless dye (1) capable of forming a yellow color is dissolved in 16.9 parts by weight of ethyl acetate. Further, 20 parts by weight of a capsule wall material (trade name: Takenate D-110N, manufactured by Takeda Chemical Industries, Ltd.) and 2 parts by weight of a capsule wall material (trade name: Millionate MR200, manufactured by Nippon Polyurethane Industry Co., Ltd.) are added thereto.

The resulting solution is added to a mixed solution containing 42 parts by weight of 8% by weight phthalic gelatin, 14 parts by weight of water and 1.4 parts by weight of a 10% by weight sodium dodecylbenzenesulfonate solution. The mixture is emulsion-dispersed at a temperature of 20° C. to obtain an emulsion. Then, 72 parts by weight of a 2.9% tetraethylenepentamine aqueous solution is added to the resulting emulsion, and the mixture is heated to 60° C. while being stirred. Two hours later, a microcapsule dispersion (1) containing the electron-donating colorless dye (1) in a core and having an average particle size of 0.5 μm is obtained.

A glass transition temperature of a material (material obtained by reacting Takenate D-110N with Millionate MR200 under conditions approximately equal to the foregoing conditions) constituting the shell of the microcapsule contained in the microcapsule dispersion (1) is 100° C.

—Preparation of a Microcapsule Dispersion (2)—

A microcapsule dispersion (2) is obtained in the same manner as in the preparation of the microcapsule dispersion (1) except that the electron-donating colorless dye (1) is changed to an electron-donating colorless dye (2). An average particle size of the microcapsule in the dispersion is 0.5 μm.

—Preparation of a Microcapsule Dispersion (3)—

A microcapsule dispersion (3) is obtained in the same manner as in the preparation of the microcapsule dispersion (1) except that the electron-donating colorless dye (1) is changed to an electron-donating colorless dye (3). An average particle size of the microcapsule in the dispersion is 0.5 μm.

The chemical structural formulas of the electron-donating colorless dyes (1) to (3) used to prepare the microcapsule dispersions are shown below.

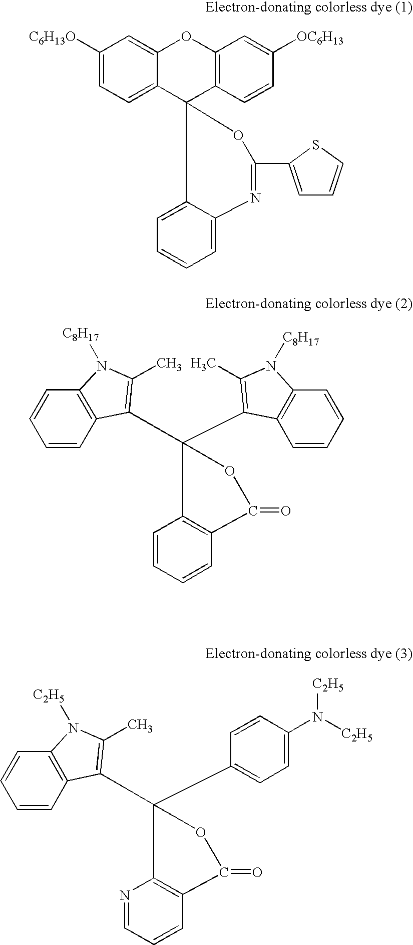

—Photo-Curing Composition Dispersion (1)—

100.0 parts by weight of a mixture of polymerizable group-containing electron-accepting compounds (1) and (2) (mixing ratio—50:50) and 0.1 part by weight of a heat polymerization inhibitor (ALI) are dissolved in 125.0 parts by weight of isopropyl acetate (solubility in water—approximately 4.3%) at 42° C. to form a mixed solution I.

18.0 parts by weight of hexaarylbiimidazole (1) [2,2′-bis(2-chlorophenyl)-4,4′,5,5′-tetraphenyl-1,2′-biimidazole], 0.5 part by weight of a nonionic organic dye and 6.0 parts by weight of an organoboron compound are dissolved in this mixed solution I at 42° C. to form a mixed solution II.

The mixed solution II is added to a mixed solution containing 300.1 parts by weight of a 8% by weight gelatin aqueous solution and 17.4 parts by weight of a 10% by weight surfactant (1) aqueous solution. The mixture is emulsified through a homogenizer (manufactured by Nippon Seiki K.K.) by 10,000 rotations for 5 minutes. Subsequently, the solvent is removed at 40° C. for 3 hours to obtain a photo-curing composition dispersion (1) having a solid content of 30% by weight.

The structural formulas of the polymerizable group-containing electron-accepting compound (1), the polymerizable group-containing electron-accepting compound (2), the heat polymerization inhibitor (ALI), the hexaarylbiimidazole (1), the surfactant (1), the nonionic organic dye and the organoboron compound which are used to prepare the photo-curing composition dispersion (1) are shown below.

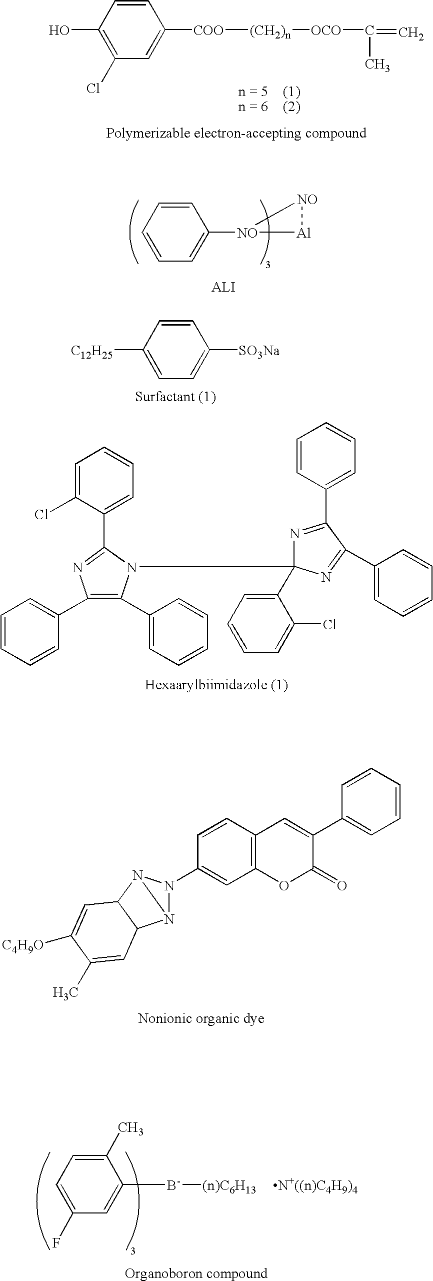

—Photo-Curing Composition Dispersion (2)—

5 parts by weight of the following polymerizable group-containing electron-accepting compound (3) is added to a mixed solution containing 0.6 part by weight of the following organoborate compound (I), 0.1 part by weight of the following spectral sensitization dye-type borate compound (I), 0.1 part by weight of the following aid (1) for providing high sensitivity and 3 parts by weight of isopropyl acetate (solubility in water—approximately 4.3%).

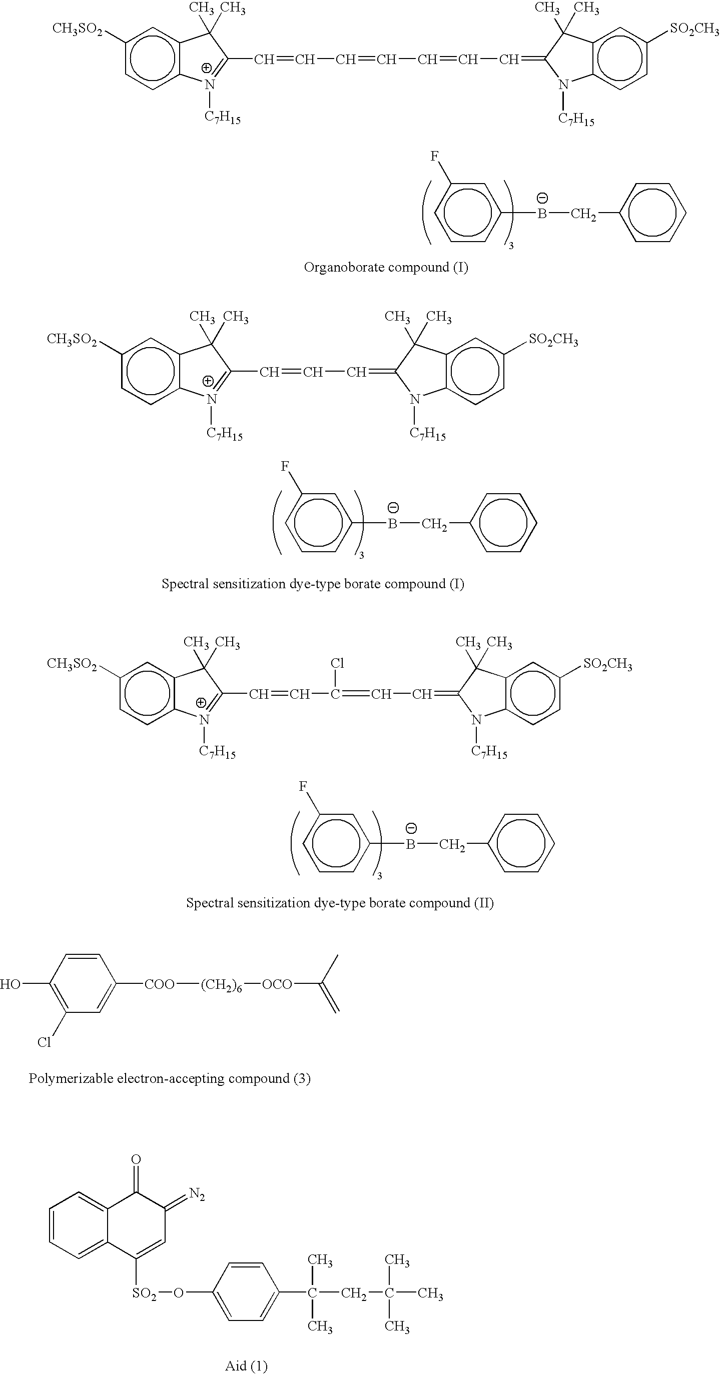

The resulting solution is added to a mixed solution containing 13 parts by weight of a 13% by weight gelatin aqueous solution, 0.8 part by weight of the following 2% by weight surfactant (2) aqueous solution and 0.8 part by weight of the following 2% by weight surfactant (3) aqueous solution, and the mixture is emulsified through a homogenizer (manufactured by Nippon Seiki K.K.) by 10,000 rotations for 5 minutes to obtain a photo-curing composition dispersion (2).

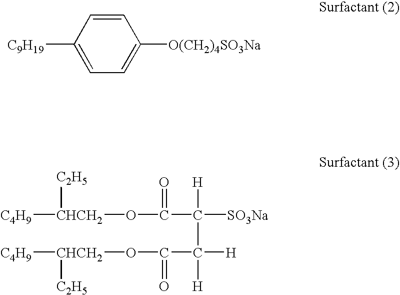

—Photo-Curing Composition Dispersion (3)—

A photo-curing composition dispersion (3) is obtained in the same manner as in the preparation of the photo-curing composition dispersion (2) except that 0.1 part by weight of the foregoing spectral sensitization dye-type borate compound (II) is used instead of the spectral sensitization dye-type borate compound (I).

—Preparation of a Resin Particle Dispersion—

styrene: 460 parts by weight

n-butyl acrylate: 140 parts by weight

acrylic acid: 12 parts by weight

dodecanethiol: 9 parts by weight

The foregoing components are mixed and dissolved to prepare a solution. Subsequently, the solution is added to a mixed solution obtained by dissolving 12 parts by weight of an anionic surfactant (Dowfax, manufactured by Rhodia) in 250 parts by weight of deionized water, and they are dispersed and emulsified in a flask to prepare an emulsion (monomer emulsion A).

Further, 1 part by weight of an anionic surfactant (Dawfax, manufactured by Rhodia) is dissolved in 555 parts by weight of deionized water, and the solution is charged into a polymerization flask. The polymerization flask is closed, and a reflux tube is mounted thereon. While nitrogen is charged and the solution is slowly stirred, the polymerization flask is heated to 75° C. in a water bath, and retained.

Subsequently, a solution obtained by dissolving 9 parts by weight of ammonium persulfate in 43 parts by weight of deionized water is added dropwise to the polymerization flask via a metering pump over the course of 20 minutes, and the monomer emulsion A is also added dropwise via the metering pump over the course of 200 minutes.

Subsequently, while stirring is gently continued, the polymerization flask is retained at 75° C. for 3 hours, and the polymerization is then terminated.

Consequently, a resin particle dispersion having a particle median size of 210 nm, a glass transition point of 51.5° C., a weight average molecular weight of 31,000 and a solid content of 42% by weight is obtained.

—Preparation of a Photosensitive/Heat-Sensitive Capsule Dispersion (1)—

microcapsule dispersion (1): 150 parts by weight

photo-curing composition dispersion (1): 300 parts by weight

polyaluminum chloride: 0.20 part by weight

deionized water: 300 parts by weight

Nitric acid is added to a starting solution obtained by mixing the foregoing components to adjust pH to 3.5, and the components are thoroughly mixed and dispersed with a homogenizer (Ultratalax T50, manufactured by IKA). The dispersion is then moved to a flask, and heated to 40° C. while being stirred in a heating oil bath with a three-one motor. After the dispersion is maintained at 40° C. for 60 minutes, 300 parts by weight of the resin particle dispersion is added, and the mixture is gently stirred at 60° C. for 2 hours. Consequently, a photosensitive/heat-sensitive capsule dispersion (1) is obtained.

A volume average particle size of the photosensitive/heat-sensitive capsule dispersed in the dispersion is 3.53 μm. Spontaneous color formation of the dispersion is not confirmed at the time of preparing this dispersion.

—Preparation of a Photosensitive/Heat-Sensitive Capsule Dispersion (2)—

microcapsule dispersion (2): 150 parts by weight

photo-curing composition dispersion (2): 300 parts by weight

polyaluminum chloride: 0.20 part by weight

deionized water: 300 parts by weight

A photosensitive/heat-sensitive capsule dispersion (2) is obtained in the same manner as in the preparation of the photosensitive/heat-sensitive capsule dispersion (1) except that the foregoing components are used in the starting solution.

A volume average particle size of the photosensitive/heat-sensitive capsule dispersed in the dispersion is 3.52 μm. Spontaneous color formation of the dispersion is not confirmed at the time of preparing this dispersion.

—Preparation of a Photosensitive/Heat-Sensitive Capsule Dispersion (3)—

microcapsule dispersion (3): 150 parts by weight

photo-curing composition dispersion (3): 300 parts by weight

polyaluminum chloride: 0.20 part by weight

deionized water: 300 parts by weight

A photosensitive/heat-sensitive capsule dispersion (3) is obtained in the same manner as in the preparation of the photosensitive/heat-sensitive capsule dispersion (1) except that the foregoing components are used in the starting solution.

A volume average particle size of the photosensitive/heat-sensitive capsule dispersed in the dispersion is 3.47 μm. Spontaneous color formation of the dispersion is not confirmed at the time of preparing this dispersion.

Photosensitive/heat-sensitive dispersion (1): 750 parts by weight

Photosensitive/heat-sensitive dispersion (2): 750 parts by weight

Photosensitive/heat-sensitive dispersion (3): 750 part by weight

A solution obtained by mixing the foregoing components is moved to a flask, and heated to 42° C. in a heating oil bath while being stirred in the flask. After the solution is retained at 42° C. for 60 minutes, 100 parts by weight of the resin particle dispersion is further added, and the mixture is gently stirred.

Subsequently, pH of the flask is adjusted to 5.0 with 0.5 mol/liter of a sodium hydroxide aqueous solution, and then heated to 55° C. while stirring is continued. While the temperature is elevated to 55° C., pH of the flask is usually decreased to 5.0 or less. However, in this case, the solution is adjusted to pH of more than 4.5 by adding dropwise a sodium hydroxide aqueous solution. In this state, the solution is retained at 55° C. for 3 hours.

After completion of the reaction, the resulting substance is cooled, filtered, thoroughly washed with deionized water, and then subjected to solid-liquid separation by Nutsche suction filtration. The substance is redispersed in 3 liters of deionized water of 40° C. in a 5-liter beaker, stirred at 300 rpm for 15 minutes, and washed. This washing procedure is repeated five times, and the substance is subjected to solid-liquid separation by Nutsche suction filtration. Then, vacuum freeze-drying is conducted for 12 hours to obtain toner particles in which the photosensitive/heat-sensitive capsules are dispersed in the styrene resin. When the particle size of the toner particles is measured with a Coulter counter, a volume average particle size D50v is 15.2 μm.

Subsequently, 1.0 part by weight of hydrophobic silica (TS720, manufactured by Cabot) is added to 50 parts by weight of the toner particles, and these are mixed with a sample mill to obtain an external toner.

(Developing Agent)

As a carrier, 30% by weight of a styrene/acrylic copolymer (number average molecular weight: 23,000, weight average molecular weight: 98,000, Tg: 78° C.) and 70% by weight of particulate magnetite (maximum magnetization: 80 emu/g, average particle size: 0.5 μm) are kneaded, pulverized, and classified to adjust a volume average particle size to 100 μm. This carrier and the foregoing toner are measured such that the concentration of the toner is 5% by weight. These are mixed in a ball mill for 5 minutes to obtain a developing agent 1.

(Image Formation)

An image forming apparatus shown in FIG. 1 is prepared.

The photoreceptor B is used as the photoreceptor 10. Scorotron is used as the charging device 12. A LED image bar of a wavelength of 780 nm in which a latent image is formed with resolution of 600 dpi is used as the exposure device 14. The developing device 72 is provided with a metallic sleeve for two-component magnetic brush development and can conduct reversal development. When the developing agent 1 is filled in the developing unit, the charge amount of the toner is from −5 to −30 μC/g.

The color data-applying device 28 is a LED image bar with resolution of 600 dpi capable of applying lights having peak wavelengths of 405 nm (exposure value: 0.2 mJ/cm²), 532 nm (exposure value: 0.2 mJ/cm²) and 657 nm (exposure value: 0.4 mJ/cm²).

The transferring device 18 has, as a transfer roll, a semiconductive roll in which a conductive elastic material is coated on an outer periphery of a conductive core. The conductive elastic material is obtained by dispersing two carbon blacks, Ketjen black and thermal black in an incompatible blend of NBR and EPDM, and has roll resistance of 10^{8.5} Ωcm and Ascar C hardness of 35 degree.

As the fixing device 22, a fixing unit used in DPC 1616 manufactured by Fuji Xerox Co., Ltd. is employed, and located in a position of 30 cm from a color data-applying point. As the light irradiation unit 24, a schaukasten with high brightness including three wavelengths of the color data-applying device is used, and an irradiation width is 5 mm.

Printing conditions are set as follows in the image forming apparatus having the foregoing structure.

Linear speed of a photoreceptor: 10 mm/sec.

Charging conditions: −800 V is applied to a screen of scorotron, and DC −500 V to a wire. At this time, a surface potential of a photoreceptor is −600 V.

Exposure: Exposure is conducted with the logic sum of image data of four colors, Y, M, C and black, and a potential after exposure is approximately −50 V.

Development bias: DC −330 V is superimposed with a rectangular wave of AC Vpp 1.2 kV (3 kHz).

Contact conditions of a developing agent: A peripheral speed ratio (developing roll/photoreceptor) is 2.0, a developing gap is 0.5 mm, an amount of the developing agent on the developing roll is 400 g/m², and a developing amount of a toner on the photoreceptor is 5 g/m² in terms of a solid image.

Transfer bias: DC +800 V is applied.

Illuminance of a light irradiation device: 12,000 lux

A chart having a gradation image portion is printed on Y, M, C, R, G, B and K colors under the foregoing conditions. The color data is applied to the toner by the combinations shown in Table 2 above. For controlling color density with luminous intensity or luminescence time, a time interval modulation in which a time of 1 dot is divided into eight intervals is employed.

(Evaluation)

Image output is conducted under the foregoing conditions, and evaluation is conducted as follows.

—Color Density—

Image density of a solid image portion is measured on Y, M and C colors with a density measuring unit X-Rite 938 (manufactured by X-Rite). Consequently, in all of these colors, the image density is 1.0 or more, and satisfactory color formation is confirmed.

—Durability of a Photoreceptor—

Image output of 20 sheets is repeated under the foregoing conditions using A4-size recording papers. Charge potentials of the photoreceptor are measured at the initial stage and after printing 20 sheets to examine durability of the photoreceptor. Consequently, the charge potential is −600 V at the initial stage, whereas the charge potential is −595 V after printing 20 sheets, and it remains almost unchanged. The image is also unchanged after printing 20 sheets in comparison to the image at the initial stage.

### Comparative Example 1

Printing and evaluation are conducted in the same manner as in EXAMPLE 1 except that the photoreceptor A is used instead of the photoreceptor B.

Consequently, while the color density is satisfactory at the initial stage, the charge potential of the photoreceptor is decreased from −600 V at the initial stage to −410 V after printing 20 sheets, and formation of a latent image is unsatisfactory. Thus, a good image cannot be obtained.

As described above, in COMPARATIVE EXAMPLE 1 using the surface layer-free photoreceptor to which the color data-applying light is directly applied, light deterioration clearly occurs in the photoreceptor by printing 20 sheets. Meanwhile, in the image forming apparatus of EXAMPLE 1 using the photoreceptor in which the color data-applying light is cut by the surface layer, stable image formation can be continued without deterioration of the photoreceptor.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An image forming apparatus color-forming applying comprising
a photoreceptor, a latent image-forming unit that forms an electrostatic latent image on the surface of the photoreceptor with light, a developing unit that develops the electrostatic latent image using a toner to form a toner image, the toner being controlled to be in a color forming state or in a non-color forming state by being applied with color data, a color data-applying unit that applies the color data with light to the toner image formed on the surface of the photoreceptor, a transferring unit that transfers the toner image color data applied onto a surface of a recording medium, a fixing unit that fixes the transferred toner image onto the surface of the recording medium, and a color formation unit that forms color of the toner image color data applied,
the photoreceptor having a surface layer that scatters or absorbs the light which the color data applying unit applies to the toner image and that transmits the light which the latent image-forming unit applies to form the electrostatic latent image.

2. The image forming apparatus as claimed in claim 1, wherein the light to apply color data is visible light, and the light to form the latent image is near-infrared light.

3. The image forming apparatus as claimed in claim 1, wherein the toner comprises a first component and a second component that are present separated from each other and forms the color when reacted with each other, and a photo-curing composition containing at least one of the first component and the second component, the photo-curing composition being in a curable state or a non-curable state by being applied applying color data with light.

4. An image forming method color-forming comprising:
forming an electrostatic latent image on a surface of a photoreceptor with light;
developing the electrostatic latent image using a toner to form a toner image, the toner being controlled to be in a color forming state or in a non-color forming state by being applied with color data;
applying the color data with light to the toner image formed on the surface of the photoreceptor;
transferring the toner image onto a surface of a recording medium;
fixing the transferred toner image onto the surface of the recording medium; and
forming color of the toner image,
the light that the latent image-forming unit applies on the surface of the photoreceptor to form the electrostatic latent image having a wavelength that the photoreceptor has sensitivity within,
and the light that the color data applying unit applies to the toner image having a wavelength that is scattered or absorbed on the surface of the photoreceptor.

5. The image forming method as claimed in claim 4, wherein the light to apply the color data is visible light, and the light to form the latent image is near-infrared light.
